(19) United States
(12) Patent Application Publication
(10) Pub. No.: US 2017/0039326 A1
(43) Pub. Date: Feb. 9, 2017

(54) IDENTIFICATION AND ANALYSIS OF COPIED AND PASTED PASSAGES IN MEDICAL DOCUMENTS

(71) Applicant: 3M INNOVATIVE PROPERTIES COMPANY, St. Paul, MN (US)

(72) Inventors: Brian J. Stankiewicz, Mahtomedi, MN (US); Kelly S. Peterson, Salt Lake City, UT (US); Garri L. Garrison, Leitchfield, KY (US)

(21) Appl. No.: 15/303,334

(22) PCT Filed: Apr. 21, 2015
(86) PCT No.: PCT/US15/26778

§ 371 Date: Oct. 11, 2016

Related U.S. Application Data
(60) Provisional application No. 61/985,190, filed on Apr. 28, 2014.

(51) Int. Cl. G06F 19/00; G06F 17/30

(52) U.S. Cl. CPC G06F 19/322; G06F 19/328; G06F 17/30371; G06F 17/30011

(57) ABSTRACT

This disclosure describes systems, devices, and techniques for identifying and analyzing copied and pasted passages of medical documents. In one example, a computer-implemented method includes receiving, by a computing device, a second medical document related to a patient encounter and determining, by the computing device, that a passage of the second medical document has been copied from a first medical document. The method may also include determining, by the computing device, a risk level for the passage, the risk level indicating a likelihood that the passage includes inaccurate information regarding the patient encounter, determining, by the computing device, that the risk level exceeds a risk threshold, and outputting, by the computing device, an indication of the passage for which the risk level exceeds the risk threshold.

### TECHNICAL FIELD

The invention relates to systems and techniques for managing medical information contained in medical documents.

### BACKGROUND

In the medical field, accurate processing of records relating to patient visits to hospitals and clinics ensures that the records contain reliable and up-to-date information for future reference. Accurate processing may also be useful for medical systems and professionals to receive prompt and precise reimbursements from insurers and other payors. Some medical systems may include electronic health record (EHR) technology that assists in ensuring records of patient visits and files are accurate in identifying information needed for reimbursement purposes. These EHR systems generally have multiple specific interfaces into which medical professionals across different healthcare facilities and settings may input information about the patients and their visits.

### SUMMARY

In general, this disclosure describes systems and techniques for identifying and analyzing copied and pasted passages (e.g., text) of a medical document. For example, systems described herein may identify one or more passages (e.g., text) of a new (or more recent) medical document that have been copied and pasted from one or more other medical documents. These copy-paste passages may include text relevant to the respective other medical documents from which the text was copied, but the text of the copy-paste passages may be inaccurate for the medical document to which the text has been pasted.

The system may also analyze any identified copy-paste passages for risk of potential error. The system may determine a risk level for each of the copy-paste passages of the medical document. The risk level may be determined based on general context, such as whether the copy-paste passage was copied from or pasted into a restricted region of a medical document, or specific context, such as typical patient-specific text of copy-paste passages or a portion of the copy-paste passage incompatible with other passages within the new medical document. The system may output, for display, indications of any copy-paste passages or only those copy-paste passages having a risk level exceeding a risk threshold. In addition, the system may remove an indication of a copy-paste passage if user input is received that confirms or modifies at least a portion of the copy-paste passage.

In one example, this disclosure describes a computer-implemented method for managing medical information, the method including receiving, by a computing device, a second medical document related to a patient encounter, determining, by the computing device, that a passage of the second medical document has been copied from a first medical document, determining, by the computing device, a risk level for the passage, the risk level indicating a likelihood that the passage includes inaccurate information regarding the patient encounter, determining, by the computing device, that the risk level exceeds a risk threshold, and outputting, by the computing device, an indication of the passage for which the risk level exceeds the risk threshold.

In another example, this disclosure describes a computerized system for managing medical information, the system including one or more computing devices configured to receive a second medical document related to a patient encounter, determine that a passage of the second medical document has been copied from a first medical document, determine a risk level for the passage, the risk level indicating a likelihood that the passage includes inaccurate information regarding the patient encounter, determine that the risk level exceeds a risk threshold, and output an indication of the passage for which the risk level exceeds the risk threshold.

In an additional example, this disclosure describes a computer-readable storage medium including instructions that, when executed, cause one or more processors to receive a second medical document related to a patient encounter, determine that a passage of the second medical document has been copied from a first medical document, determine a risk level for the passage, the risk level indicating a likelihood that the passage includes inaccurate information regarding the patient encounter, determine that the risk level exceeds a risk threshold, and output an indication of the passage for which the risk level exceeds the risk threshold.

The details of one or more examples of the described systems, devices, and techniques are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example distributed system configured to identify and analyze copied and pasted passages of a medical document consistent with this disclosure.

FIG. 2 is a block diagram illustrating the server and repository of the example distributed system of FIG. 1.

FIG. 3 is a block diagram illustrating a stand-alone computing device configured to identify and analyze copy-paste passages of a medical document consistent with this disclosure.

FIG. 4 is an illustration of an example medical document with a copy-paste passage from another medical document.

FIG. 5A is an illustration of an example medical document with a copy-paste passage from another medical document.

FIG. 5B is an illustration of an example medical document with a copy-paste passage incompatible with another passage of the same medical document.

FIG. 6 is a flow diagram illustrating an example workflow for analyzing medical documents and determining one or more copy-paste passages in a medical document.

FIG. 7 is a flow diagram illustrating an example technique for determining a risk level for each copy-paste passage of a medical document.

FIG. 8 is a flow diagram illustrating an example technique for determining a risk level based on general risk factors.

FIG. 9 is a flow diagram illustrating an example technique for determining a risk level based on specific risk factors.

FIG. 10 is an illustration of an example user interface screen that includes a notification regarding a copy-paste passage.

FIG. 11 is an illustration of an example user interface screen that includes a panel identifying high risk copy-paste passages.

FIG. 12 is an illustration of an example user interface screen that includes indications of high risk copy-paste passages in a medical document.

### DETAILED DESCRIPTION

This disclosure describes systems and techniques for identifying and analyzing copied and pasted passages of a medical document. When a physician visits with a patient (e.g., a patient encounter), the physician may perform various tasks such as evaluating the patient, reviewing medical history of the patient, and determining the current medical condition of the patient. The physician may also, or alternatively, perform a medical procedure on the patient during the patient encounter that may be related to the medical condition. The physician (or other medical professional such as a physician's assistant or nurse) typically uses a computerized medical record system to enter information (e.g., into a medical document) documenting aspects of the patient encounter as medical information related to the patient. To reduce the amount of time required to enter this medical information, the computerize medical record system may allow the physician to copy a passage (e.g., a text passage) of a previous medical document for the patient or a passage of a medical document for a different patient and paste the copied passage into the new medical document being generated by the physician.

The copy and paste functionality provided by the computerized medical record system may encourage physicians to enter medical information regarding the patient encounter by reducing the time required to type text into a new medical document. This more efficient process may effectively promote more complete electronic health records (EHR) for patients. However, the copy and paste functionality may also increase the probability that the copied and pasted passages (i.e., copy-paste passages) retain information specific to the old medical document from which the copy-paste passage was copied. Therefore, copy-paste passages present in a new medical document may include inaccurate (i.e., erroneous) information with regard to the patient encounter for which the new medical document has been generated. Although some copy-paste passages may include only benign information, other copy-paste passages may include inaccurate information that could result in negative medical outcomes for the patient, overpayment or underpayment for physician services, documentation defined as fraudulent or possible litigation. For example, another physician may read a copy-paste passage that includes inaccurate laboratory information and order unnecessary medications that could harm the patient. As another example, a copy-paste passage may describe diagnoses or procedures not addressed or performed at the patient encounter that get coded and result in overbilling for the patient encounter in question. In another example, a copy-paste passage may describe patient complications that are no longer active or medications prescribed to a patient that are discontinued or no longer manufactured. As another example, a copy-paste passage may result in over-documentation by adding impertinent documentation to create the appearance to support overpayment which may be classified as fraud by medical or governmental organizations such as the Centers for Medicare and Medicaid Services (CMS).

As described herein, various systems and techniques may identify copied and pasted passages (i.e., copy-paste passages) in medical documents, determine a risk level of the copy-paste passages, and output, based on the risk level of each copy-paste passage, an indication of the respective copy-paste passages in the medical document. For example, computing devices (e.g., a networked server or standalone computing device) described herein may identify one or more copy-paste passages (e.g., a block of text) of a medical document that have been copied from one or more other medical documents and pasted into the medical document. A passage may include one or more characters combined in one or more words, one or more phrases, sentences, paragraphs, any combination thereof, or comprise an entire section and/or document within an EHR. Although a passage may typically be a continuous text string, a passage may contain two or more text strings that are not continuous (e.g., text strings broken by formatting or other sections of text). A computing device may analyze one or more previously generated other medical documents and compare the content of each of the previously generated medical documents to the content of the medical document in order to identify any identical passages of the medical document. Each of the identical passages may be determined as copy-paste passages in the medical document.

The computing device may also analyze any determined copy-paste passages for risk of causing inaccuracies, or error, in the medical document. The computing device may determine a risk level for each of the copy-paste passages of the medical document. The computing device may determine the risk level based on general context such as whether the copy-paste passage was copied from a restricted region of a prior medical document or pasted into a restricted region of the newer medical document. The computing device may also, or alternatively, determine the risk level based on specific context such as typical patient-specific text of copy-paste passages or a portion of the copy-paste passage incompatible with other passages within the medical document (e.g., intradocument incompatible passages resulting from the copy-paste passage). The computing device may employ natural language processing (NLP) and/or other techniques to determine when these specific risks occur within the copy-paste passage and/or between the copy-paste passage and other passages within the medical document.

The computing device may output, for display, indications of any copy-paste passages or only those copy-paste passages having a risk level exceeding a risk threshold. For example, the computing device may highlight the copy-paste passages or only a portion of the copy-paste passages responsible for the elevated risk level. In addition, the computing device may be configured to receive user input confirming that a copy-paste passage is correct (i.e., the copy-paste passage does not contain any inaccuracies) and/or user input modifying at least a portion of a copy-paste passage to correct any inaccuracies. In response to receiving the confirmation input or modification input, the computing device may remove the indication of the respective copy-paste passage because the potentially inaccurate information has been corrected or confirms as accurate.

The computing device may perform any of these processes with regard to copy-paste passages in real-time (e.g., copy-paste passages can be identified and analyzed for risk as a medical document is created) or as a post-processing step (e.g., copy-paste passages can be identified and analyzed for risk on one or more medical documents already part of the patient's EHR). The computing device may output the indications of copy-paste passages of elevated risk levels to a medical professional, a medical coding professional, a compliance officer within a healthcare organization, a government regulatory agency, or any other user interested in the accuracy of medical documents. Although the user is generally described as a physician herein, the system may provide notifications and/or access to the copy-paste passages or other related information described herein. In this manner, the computing device may allow the author and/or third parties to review copy-paste passages in real-time during generation of new medical documents and/or after the medical documents are generated and added to the patient's EHR. In this manner, non-authors of medical documents may also review copy-paste passages (and the medical documents in which they reside). The computing device may provide mechanisms for non-authors to flag copy-paste passages and/or related medical documents for the authors of the documents and request author input that corrects any incorrect information within the copy-paste passages. The examples described herein will refer to medical documents, but the medical documents may be portions of a single clinical documentation datastore of a patient or include one or more documents each including one or more separated regions, pages, or sections each including medical data related to a patient.

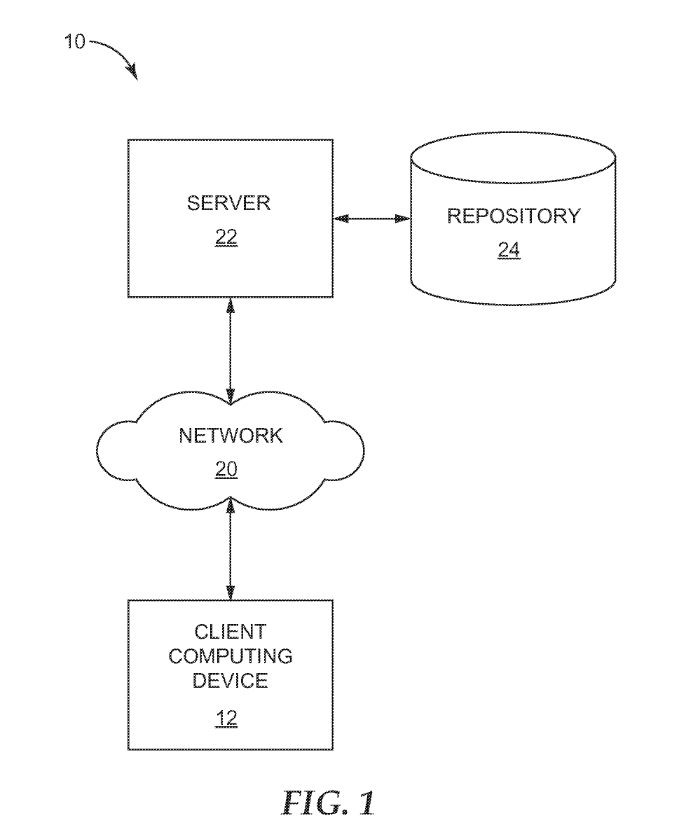

FIG. 1 is a block diagram illustrating an example distributed system configured to identify and analyze copied and pasted passages of a medical document consistent with this disclosure. As described herein, system 10 may include one or more client computing devices 12, a network 20, server computing device 22, and repository 24. Client computing device 12 may be configured to communicate with server 22 via network 20. Server 22 may receive various requests from client computing device 12 and retrieve various information from repository 24 to address requests from client computing device 12. In some examples, server 22 may generate information, such as identified copy-paste passages and risk levels for each copy-paste passage for client computing device 12.

Server 22 may be and/or include one or more computing devices connected to client computing device 12 via network 20. Server 22 may perform the techniques described herein, and a user may interact with system 10 via client computing device 12. Network 20 may include a proprietary or non-proprietary network for packet-based communication. In one example, network 20 may include the Internet, in which case each of client computing device 12 and server 22 may include communication interfaces for communicating data according to transmission control protocol/internet protocol (TCP/IP), user datagram protocol (UDP), or the like. More generally, however, network 20 may include any type of communication network, and may support wired communication, wireless communication, fiber optic communication, satellite communication, or any type of techniques for transferring data between two or more computing devices (e.g., server 22 and client computing device 12).

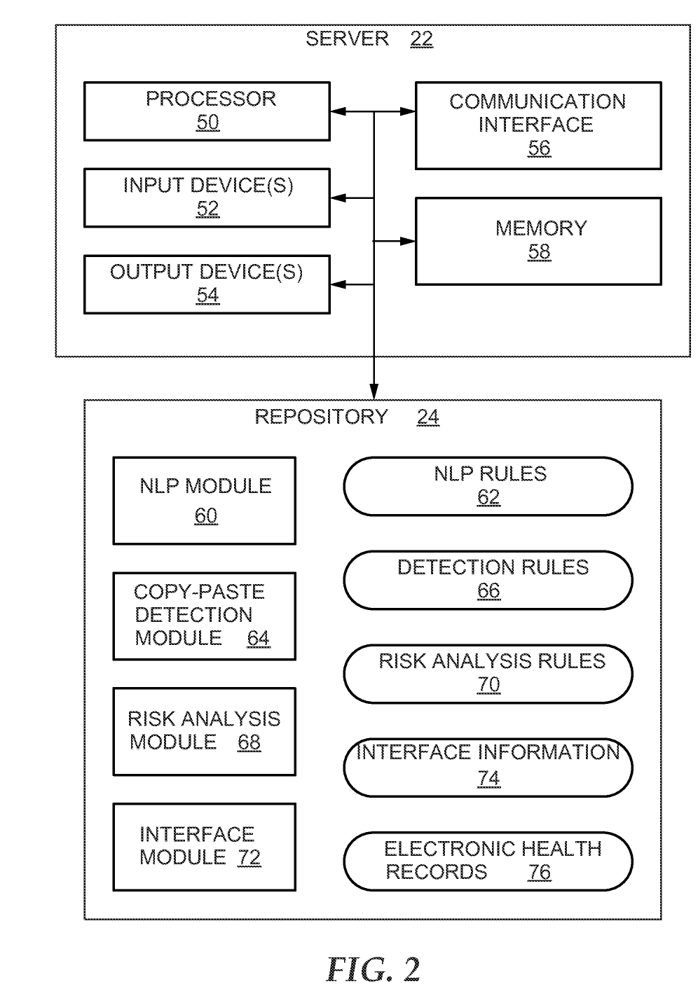

Server 22 may include one or more processors, storage devices, input and output devices, and communication interfaces, as described in FIG. 2. Server 22 may be configured to provide a service to one or more clients, such as identifying copy-paste passages in a medical document, determining risk levels for each copy-paste passage, outputting indications of the copy-paste passages based on the determined risk levels. Server 22 may operate on within a local network or be hosted in a Cloud computing environment. Client computing device 12 may be a computing device associated with an entity (e.g., a hospital, clinic, university, or other healthcare organization) that provides information to a physician during a patient encounter and/or receives input documenting aspects of the patient encounter. Examples of client computing device 12 include personal computing devices, computers, servers, mobile devices, smart phones, and tablet computing devices. Client computing device 12 may be configured to upload generated medical information to server 22 for analysis regarding any copy-paste passages by server 22. Alternatively, client computing device 12 may be configured to retrieve copy-paste passages and/or risk levels generated by server 22 and stored in repository 24. Server 22 may also be configured to communicate with multiple client computing devices 12 associated with the same entity and/or different entities.

When a physician sees a patient in either an outpatient clinic or during an office visit (e.g., a patient encounter), the physician typically performs an evaluation of the patient, the patient's medical history and/or the patient's current medical condition. The physician may also perform a medical procedure on the patient during the patient encounter or prescribe treatment related to the patient's medical condition. The physician (or other medical professional) may record information related to the patient and the patient encounter in a medical document. Client computing device 12 may allow, via the medical documentation software, the physician to copy text passages from previously generated medical documents related to the patient or medical documents related to other patients. These previously generated medical documents may be stored by client computing device 12 and/or repository 24, and retrieved for viewing and/or selection by the physician. Client computing device 12 may also allow the physician to paste copied text passages into a medical document to generate the medical document. The pasted text passages (i.e., copy-paste passages) can reduce the amount of typing a physician is required to do when generating the medical document for the patient encounter. However, as discussed above, copy-paste passages may introduce, if not corrected by the physician, inaccuracies to the medical document if the copy-paste passage includes information specific to the copied medical document, the different patient encounter of the copied medical document, and/or a different patient associated with the copied medical document.

As described herein, system 10 may operate to identify copy-paste passages in medical documents, determine a risk level that the copy-paste passage could include inaccuracies, and output an indication of copy-paste passages. System 10 may allow the physician to utilize copy and paste functionality to more efficiently generate medical documents for patient encounters while limiting the risk of populating medical documents with inaccurate information. System 10 may, in real-time or after a medical document has been completed and stored in the EHR, output an indication of copy-paste passages having an elevated risk level to flag potential erroneous information. System 10 may also receive modifications to copy-paste passages or confirmation that the copy-paste passage is correct for the medical document. In this manner, system 10 may assist the physician or other user of client computing device in minimizing inaccurate information included in medical documents due to copy-paste passages. System 10 may also provide a regulatory function by storing data regarding high risk copy-paste passages resulting from each physician and facilitating the correction of inaccurate medical documents before the inaccurate information negatively impacts patient treatment or causes overbilling or underbilling problems.

In one example, system 10 may include one or more computing devices (e.g., server 22) configured to receive one or more medical documents related to respective patient encounters with one or more physicians. System 10 may store these medical documents in repository 24 for later use and/or incorporation in the EHR for the patient. Server 22 may also retrieve these previously generated medical documents for display to physicians at a later time via client computing device 12. During or after a patient encounter, client computing device 12 may receive user input generating a medical document describing aspects of the patient encounter. Medical documents related to the patient encounter may include a natural language representing the patient encounter as created by the physician. For example, the physician may dictate or type various background information, observations, diagnoses, procedures performed, or any other notes regarding the patient encounter. Dictated or narrated information may include voice data recognized and converted to text for processing via NLP techniques described herein.

Client computing device 12 may also receive user input copying text passages from previously generated medical documents and pasting the text passages into the new medical document such that the new medical document includes copy-paste passages. The previously generated medical documents are typically different and separate from the new medical document. However, in other examples, client computing device 12 may also receive user input copying and pasting text passages within the currently generated medical document where the previously generated medical document and new document are part of the same larger document. As the new medical document is saved by client computing device 12, client computing device 12 may transmit the new medical document to server 22 via network 20. Server 22 may store the new medical document in repository 24. In addition, server 22 may analyze the new medical document for copy-paste passages at risk for inaccuracies regarding the patient encounter.

Server 22 may be configured to receive the new medical document related to the patient encounter and determine that a passage of the new medical document has been copied from previously generated medical document (e.g., that the passage is a copy-paste passage), where the new medical document has been generated after the previously generated medical document. Server 22 may also be configured to determine a risk level for the copy-paste passage, the risk level indicating a likelihood that the copy-paste passage includes inaccurate information regarding the patient encounter. Since some copy-paste passages may not cause any negative activity even if inaccurate information is included, the risk level may separate these benign copy-paste passages from potentially problematic copy-paste passages. Server 22 may thus determine that the risk level exceeds a risk threshold and output an indication of the copy-paste passage for which the risk level exceeds the risk threshold. This indication may be a flag to the physician or other user of the copy-paste passage.

In some examples, server 22 may determine that the passage of the new medical document has been copied from the previously generated medical document by searching for identical text shared between the medical documents. Server 22 may compare content of the new medical document to content of one or more previously generated medical documents, the one or more other medical documents including the previously generated medical document, and identify, based on the comparison, a first continuous text string from the content of new medical document as identical to a second continuous text string of the content of the previously generated medical document. Server 22 may then determine that the first continuous text string having a number of words greater than a word minimum is the copy-paste passage of the new medical document that has been copied from the previously generated medical document. In addition, or alternatively, server 22 may compile all identical text strings and arrange them in order of decreasing length (e.g., length measured in number of words and/or number of characters). Server 22 may then select a predetermined number of the longest identical text strings as copy-pasted passages.

In one example, the risk level may be defined as one of a low risk level or a high risk level, the high risk level exceeding the risk threshold and the low risk level not exceeding the risk threshold. In other words, copy-paste passages having a low risk level may not need to be addressed by the physician or other user, whereas copy-paste passages having a high risk level may benefit from additional attention from the user. In other examples, the risk level may be described as a “no risk” level and a “risky” level, where copy-paste passages are identified has having no risk or at least some risk. The passages determined to have at least some risk exceeding the risk threshold of no risk. Alternatively, the risk level may include three or more different risk levels (e.g., a scale of 1 to 5 or a scale of 1 to 10) to more specifically quantify the risk of each copy-paste passage. The risk threshold may then be set by the physician, the clinic, or even a government regulatory agency to address only the risk that is determined to be an issue.

The source and/or destination of a copy-paste passage may also be used to determine the risk level of the copy-paste passage. A medical document may include different regions such as a patient background and history region, symptoms region, examination region, vital signs region, laboratory/diagnostic results region, medical region, diagnosis region, and treatment region. The text in each of these regions of one medical document may be more or less applicable to regions of another medical document. In this manner, one or more regions may be identified as restricted regions that typically include information specific to the patient encounter of that particular medical document. For example, copying text from a background region from one medical document and pasting the text into the background region of a new medical document may be pose low to no risk that the pasted text can adversely affect patient treatment or billing activities. However, copying text from a laboratory/vital sign region of one medical document and pasting the text into the laboratory/vital sign region of a new medical document may pose a high risk that the pasted text includes information not accurate for the patient encounter of the new medical document. In some examples, only one of the source region or destination region may need to be restricted to pose a high risk of error. Copying text passages from one of these restricted regions of a previously generated medical document, and/or pasting copied text passages into a restricted of a new medical document, may increase the risk that the new medical document includes inaccurate information for the patient encounter for which the medical document is describing. Server 22 may thus be configured to determine, by a risk analysis module for example, a high risk level exceeding the risk threshold for the copy-paste passage that has been at least one of copied from a restricted region of a previously generated medical document or pasted into a restricted region of the new medical document. In this manner, the restricted region may include medical information typically different between different patient encounters.

In addition, or as an alternative , to restricted regions, server 22 may determine high risk levels for copy-paste passages containing a text string that is typically different between different patient encounters. These “risky” test strings may include words typically used to describe current patient conditions and/or numbers identifying current values of items such as patient lab reports, vital signs, or objective patient feedback. Server 22 may utilize natural language processing (NLP) techniques to identify these risky test strings and/or key words that typically precede or are included in the risky text strings of the copy-paste passages.

Server 22 may also determine risk levels of copy-paste passages based on incompatibilities within the new medical document to which the copy-paste passages have been added. In other words, server 22 may utilize NLP or other techniques to identify when the copy-paste passages include information that is incompatible with other passages within the same medical document. For example, the information may be incompatible when the information from the copy-paste passage includes a different grammatical tense than text of the other passages in the medical document, the information of the copy-paste passage is in direct conflict with information of the other passages (e.g., the copy-paste passage states the patient is not in pain and another passage states the patient is in pain), or the information of the copy-paste passage contains subject matter inconsistent with subject matter of the other passages (e.g., a term or phrase within the copy-paste passage is not typically present in conjunction with another term or phrase within a different passage of the medical document). Server 22 may determine, via a risk analysis module of the computing device, a high risk level exceeding the risk threshold for the copy-paste passage that contains information incompatible with other passages of the new medical document.

Server 22 may output indications of any copy-paste passages having a risk level exceeding the risk threshold for display to the user (e.g., the physician or compliance officer). Server 22 may output this indication to client computing device 12 via network 20 for display at a display device of client computing device 12. In one example, server 22 may output the indication of the copy-paste passage as highlighted text within the medical document. The highlighted text may flag the text as a copy-paste passage that requires attention to ensure that the copy-paste passage does not include inaccurate information with respect to the patient encounter described by the medical document. In another example, server 22 may underline the copy-paste passage, change the color of the text within the copy-paste passage, insert arrows or brackets to identify the copy-paste passages, or provide any other such indication. In some examples, server 22 may indicate a smaller portion of the copy-paste passage that triggered the high risk level instead of the entire copy-paste passage. In this manner, server 22 may quickly identify the potential inaccurate information of the copy-paste passage for copy-paste passages that can include hundreds or even thousands of words across many pages of the medical document.

As described herein, the inaccurate information of a copy-paste passage may include information specific to the previously generated medical document from which the passage was copied instead of being specific to the new medical document into which the passage was pasted. In this manner, the information of the copy-paste passage may be correct in the context of the medical document from which the passage was copied, but the information becomes inaccurate because it is being used to erroneously describe a different patient encounter for the new medical document into which the copy-paste passage was pasted. In some examples, the new medical document may be related to one patient encounter and a previously generated medical document may be related to a different patient encounter for the same patient. In other examples, the new medical document may be related to a patient encounter for one patient whereas the previously generated medical document may be related to a patient encounter for a different patient. In this manner, copy-paste passages may occur between medical documents for the same patient and/or between medical documents for different patients.

Once server 22 has output the indication of one or more copy-paste passages, server 22 may receive user input addressing the copy-paste passages via a user interface provided by client computing device 12. For example, sever 22 may be configured to receive, from a medical professional associated with the patient encounter (e.g., the patient's physician), user input that either confirms the copy-paste passage is correct or modifies at least a portion of the copy-paste passage to remove any inaccuracies. Responsive to receiving the user input addressing the identified copy-paste passages, server 22 may remove the indication of the copy-paste passages for which the risk level exceeds the risk threshold. In this manner, server 22 may provide indications of copy-paste passages as an interactive process in which server 22 flags potentially risky copy-paste passages and removes the flags when the risk of the copy-paste passages no longer are present. In this manner, server 22 may analyze modifications to the copy-paste passages and check if the modifications eliminate the one or more inaccuracies of the copy-paste passage. In some examples, server 22 may perform another iteration of the identification of copy-paste passages and risk analysis on the modified copy-paste passages to ensure the physician has not merely copied additional text from another medical document.

Identification of copy-paste passages may be performed by comparing text from one medical document to other medical documents. However, server 22 and/or client computing device 12 may identify copy-paste passages using other techniques in addition to, or alternative to, the comparison process. For example, client computing device 12 may monitor user input for input that utilizes any copy and paste functionality. This functionality may be facilitated by the operating system and/or an application that supports the generation of medical documents. An example of copy and paste functionality may include selection of the “control” and “C” keys on a keyboard to copy text and subsequent selection of the “control” and “V” keys on the keyboard to paste the text into another medical document. Client computing device 12 may log these actions (e.g., store the data and/or create metadata for the medical document) and pass an indication of the detection to server 22 for analysis. Client computing device 12 may track the region of the medical document from which text was copied and/or track the region of the medical document into which the text was pasted. In some examples, only the paste functionality may need to be detected and tracked. By directly tracking copy and paste actions from the user, copy-paste passages may be identified without comparing text from one medical document to text from other medical documents.

The processes described with respect to FIG. 1 and herein may be performed by one or more servers 22. In other examples, client computing device 12 may perform one or more of the steps of the identification of copy-paste passages, risk analysis of the copy-paste passages, or any other related functionality. In this manner, system 10 may be referred to as a distributed system in some examples. Server 22 may utilize additional processing resources by transmitting some or all of the medical documents to additional computing devices.

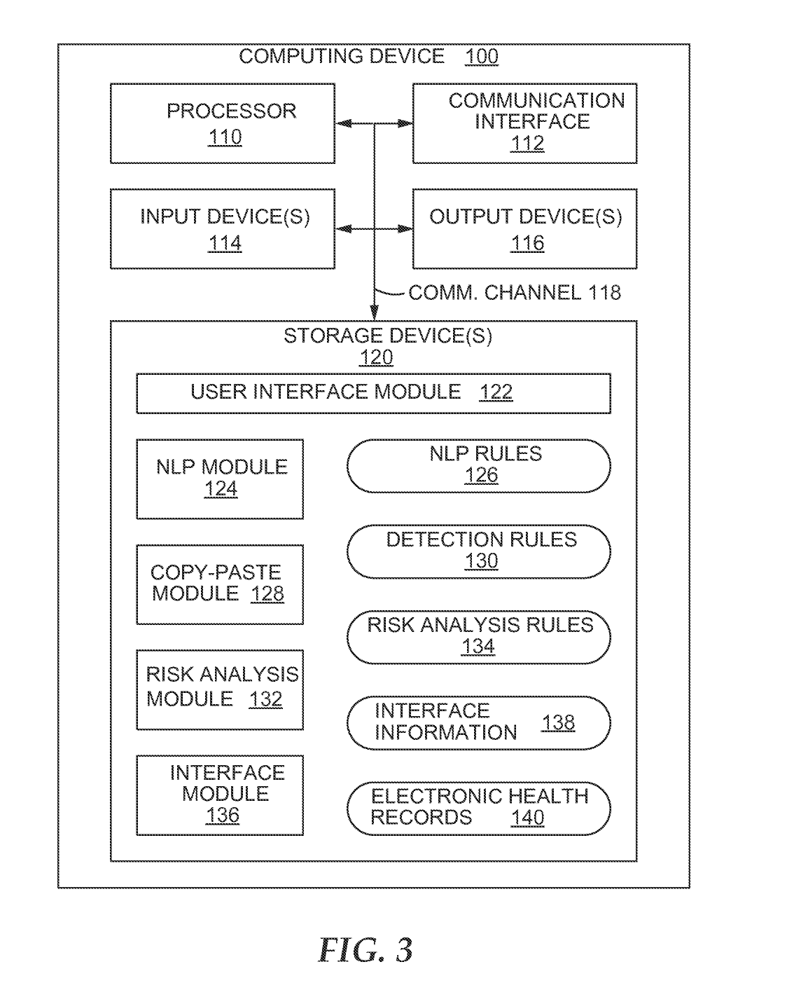

Client computing device 12 may be used by a user (e.g., a medical professional such as physician, a healthcare facility administrator, a governmental regulatory agency, or a medical coding expert) to generate medical documents as described herein. Client computing device 12 may include one or more processors, memories, input and output devices, communication interfaces for interfacing with network 20, and any other components that may facilitate the processes described herein. In some examples, client computing device 12 may be similar to computing device 100 of FIG. 3. In this manner, client computing device 12 may be configured to perform one or more steps of the identification of copy-paste passages and/or risk analysis of the copy-paste passages with the aid of server 22, in some examples.

FIG. 2 is a block diagram illustrating the server and repository of the example of FIG. 1. As shown in FIG. 2, server 22 includes processor 50, one or more input devices 52, one or more output devices 54, communication interface 56, and memory 58. Server 22 may be a computing device configured to perform various tasks and interface with other devices, such as repository 24 and client computing devices (e.g., client computing device 12 of FIG. 1). Although repository 24 is shown external to server 22, server 22 may include repository 24 within a server housing in other examples. Server 22 may also include other components and modules related to the processes described herein and/or other processes. The illustrated components are shown as one example, but other examples may be consistent with various aspects described herein.

Processor 50 may include one or more general-purpose microprocessors, specially designed processors, application specific integrated circuits (ASIC), field programmable gate arrays (FPGA), a collection of discrete logic, and/or any type of processing device capable of executing the techniques described herein. In some examples, processor 50 or any other processors herein may be described as a computing device. In one example, memory 58 may be configured to store program instructions (e.g., software instructions) that are executed by processor 50 to carry out the techniques described herein. Processor 50 may also be configured to execute instructions stored by repository 24. Both memory 58 and repository 24 may be one or more storage devices. In other examples, the techniques described herein may be executed by specifically programmed circuitry of processor 50. Processor 50 may thus be configured to execute the techniques described herein. Processor 50, or any other processors herein, may include one or more processors.

Memory 58 may be configured to store information within server 22 during operation. Memory 58 may comprise a computer-readable storage medium. In some examples, memory 58 is a temporary memory, meaning that a primary purpose of memory 58 is not long-term storage. Memory 58, in some examples, may comprise a volatile memory, meaning that memory 58 does not maintain stored contents when the computer is turned off Examples of volatile memories include random access memories (RAM), dynamic random access memories (DRAM), static random access memories (SRAM), and other forms of volatile memories known in the art. In some examples, memory 58 is used to store program instructions for execution by processor 50. Memory 58, in one example, is used by software or applications running on server 22 (e.g., one or more of modules 60, 64, 68, and 72) to temporarily store information during program execution.

Input devices 52 may include one or more devices configured to accept user input and transform the user input into one or more electronic signals indicative of the received input. For example, input devices 52 may include one or more presence-sensitive devices (e.g., as part of a presence-sensitive screen), keypads, keyboards, pointing devices, joysticks, buttons, keys, motion detection sensors, cameras, microphones, or any other such devices. Input devices 52 may allow the user to provide input via a user interface.

Output devices 54 may include one or more devices configured to output information to a user or other device. For example, output device 54 may include a display screen for presenting visual information to a user that may or may not be a part of a presence-sensitive display. In other examples, output device 54 may include one or more different types of devices for presenting information to a user. Output devices 54 may include any number of visual (e.g., display devices, lights, etc.), audible (e.g., one or more speakers), and/or tactile feedback devices. In some examples, output devices 54 may represent both a display screen (e.g., a liquid crystal display or light emitting diode display) and a printer (e.g., a printing device or module for outputting instructions to a printing device). Processor 50 may present a user interface via one or more of input devices 52 and output devices 54, whereas a user may control the generation and analysis of medical documents via the user interface. In some examples, the user interface generated and provided by server 22 may be output for display by a client computing device (e.g., client computing device 12).

Server 22 may utilize communication interface 56 to communicate with external devices via one or more networks, such as network 20 in FIG. 1, or other storage devices such as additional repositories over a network or direct connection. Communication interface 56 may be a network interface card, such as an Ethernet card, an optical transceiver, a radio frequency transceiver, or any other type of device that can send and receive information. Other examples of such communication interfaces may include Bluetooth, 3G, 4G, and WiFi radios in mobile computing devices as well as USB. In some examples, server 22 utilizes communication interface 56 to wirelessly communicate with external devices (e.g., client computing device 12) such as a mobile computing device, mobile phone, workstation, server, or other networked computing device. As described herein, communication interface 56 may be configured to receive clinical documentation, codes, and/or transmit suggested codes and/or queries over network 20 as instructed by processor 50.

Repository 24 may include one or more memories, repositories, databases, hard disks or other permanent storage, or any other data storage devices. Repository 24 may be included in, or described as, cloud storage. In other words, information stored in repository 24 and/or instructions that embody the techniques described herein may be stored in one or more locations in the cloud (e.g., one or more repositories 24). Server 22 may access the cloud and retrieve or transmit data as requested by an authorized user, such as client computing device 12. In some examples, repository 24 may include Relational Database Management System (RDBMS) software. In one example, repository 24 may be a relational database and accessed using a Structured Query Language (SQL) interface that is well known in the art. Repository 24 may alternatively be stored on a separate networked computing device and accessed by server 22 through a network interface or system bus, as shown in the example of FIG. 2. Repository 24 may in other examples be an Object Database Management System (ODBMS), Online Analytical Processing (OLAP) database or other suitable data management system.

Repository 24 may store instructions and/or modules that may be used to perform the techniques described herein related to identifying copy-paste passages, determining risk levels for each copy-paste passages, and outputting indications of the copy-paste passages. As shown in the example of FIG. 2, repository 24 includes NLP module 60, copy-paste detection module 64, risk analysis module 68, and interface module 72. Processor 50 may execute each of modules 60, 64, 68, and 72 as needed to perform various tasks. Repository 24 may also include additional data such as information related to the function of each module and server 22. For example, repository 24 may include NLP rules 62, detection rules 66, risk analysis rules 70, interface information 74, and electronic health records 76. Repository 24 may also include additional data related to the processes described herein. In other examples, memory 58 or a different storage device of server 22 may store one or more of the modules or information stored in repository 24.

As described herein, server 22 may receive medical information entered (e.g., created) by a physician or at the direction of a physician to represent an encounter with a patient. For example, processor 50 may receive one or more medical document describing the patient encounter or including notes regarding the patient. These medical documents may be stored in Electronic Health Records (EHR) 76 along with previously generated and received medical documents. EHR 76 may include medical documents for a single patient or medical documents for a plurality of respective patients.

Processor 50 may be configured to receive a new medical document (or a medical document for which copy and paste passages with be detected) related to a patient encounter. Processor 50 may execute copy-paste detection module 64 to determine that a passage of the new medical document has been copied from previously generated medical document, where the new medical document has been generated after the previously generated medical document. Copy-paste detection module 64 may determine that the passage of the new medical document has been copied from the previously generated medical document by searching for identical text shared between the medical documents, according to the detection rules 66 stored in repository 24. Copy-paste detection module 64 may compare content of the new medical document to content of one or more previously generated medical documents stored in EHR 76 or retrieved from another datastore. In this manner, a determined copy-paste passage may have been actually copied as a block of text and pasted into the new medical document or a user may have typed out an identical (or nearly identical) block of text without utilizing a copy and paste shortcut function. However, for the purposes of this disclosure, copy-paste detection module 64 will be described as determining that a text passage has been copied when the text passage is identical (or nearly identical) to another text passage from a different medical document.

Copy-paste detection module 64 may identify, based on the comparison, a first continuous text string from the content of new medical document as identical to a second continuous text string of the content of the previously generated medical document. Copy-paste detection module 64 may then determine that the first continuous text string having a number of words greater than a word minimum is a copy-paste passage of the new medical document that has been copied from the previously generated medical document. The word minimum may be utilized to prevent common short phrases from being included as copy-paste passages. In addition, or alternatively, copy-paste detection module 64 may compile all identical text strings and arrange them in order of decreasing length (e.g., length measured by the number of words and/or the number of characters in the text string). Copy-paste detection module 64 may then select a predetermined number of the longest identical text strings as copy-pasted passages. This selection process may be used to target large blocks of text that have been copied and pasted into the new medical document, as larger blocks of text are more likely to include inaccurate information for the new medical document than smaller blocks of text. In other examples, copy-paste detection module 64 may determine that any identical test strings are copy-paste passages regardless of length.

In another example, copy-paste detection module 64 may determine a text passage has been copied and pasted by determining the percentage of a text passage that is identical to a text passage from another medical document. For example, copy-paste detection module 64 may determine the percentage of the text in a region of the medical document that is identical to text in the same (or different) region of another medical document. Higher percentages of identical text may indicate that the text passage should be determined as a copy-paste passage. In one example, risk analysis module 68 may determine that a text passage that is greater than 90 percent identical to another text passage is a copy-paste passage. However, other percent identical (or percentage match) thresholds may be used, such as 80 percent or 95 percent. In some examples, determined copy-paste passages may be ordered for display to a user according to the percentage of identical content (e.g., higher percentages first) and/or with the percent of identical content listed with a description of the respective copy-paste passage.

Instead of, or in addition to, determining copy-paste passages by comparing text from one medical document to other medical documents (e.g., identifying identical text passages), copy-paste detection module 64 may be configured to determine copy-paste passages using other techniques. For example, client computing device 12 may monitor user input for input that utilizes any copy and paste functionality and transmit an indication of such functionality to copy-paste detection module 64. This functionality may be facilitated by the operating system and/or an application that supports the generation of medical documents. An example of copy and paste functionality may include selection of the “control” and “C” keys on a keyboard to copy text and subsequent selection of the “control” and “V” keys on the keyboard to paste the text into another medical document. Copy-paste detection module 64 may log these actions (e.g., store the data and/or create metadata for the medical document) to determine which passages have been copied and pasted into each medical document. Copy-paste detection module 64 may also track the region of the medical document from which text was copied and/or track the region of the medical document into which the text was pasted. In some examples, only the paste functionality may need to be detected and tracked. By directly tracking copy and paste actions from the user, copy-paste detection module 64 may identify copy-paste passages directly without comparing text from one medical document to text from other medical documents.

Once the copy-paste passages are identified for a medical document, copy-paste detection module 64 may transmit indications of each copy-paste passage to risk analysis module 68. Processor 50 may execute risk analysis module 68 to determine a risk level for the copy-paste passage, the risk level indicating a likelihood that the copy-paste passage includes inaccurate information regarding the patient encounter of the medical document into which the copy-paste passage was pasted. The risk level of a copy-paste passage may provide a more accurate indication of whether a copy-paste passage will result in erroneous actions with regard to treatment of the patient or billing for physician and clinic resources. Risk analysis module 68 may thus determine that the risk level exceeds a risk threshold before the copy-paste passage is identified to the user via interface module 72.

Risk analysis module 68 may use different risk levels to effectively differentiate between different copy-paste passages. The risk levels may allow server 22 to focus the user's attention to copy-paste passages that could include problematic inaccuracies instead of merely marking every copy-paste passage detected. In one example, the risk level may be defined as one of a low risk level or a high risk level, the high risk level exceeding the risk threshold and the low risk level not exceeding the risk threshold. In other words, copy-paste passages having a low risk level may not need to be addressed by the physician or other user, whereas copy-paste passages having a high risk level may benefit from additional attention from the user (e.g., to correct inaccuracies that may actually affect patient outcomes or administrative reports).

In other examples, risk analysis module 68 may be configured to establish risk levels of three or more different risk levels (e.g., a scale of 1 to 5 or a scale of 1 to 10) to more specifically quantify the risk of each copy-paste passage. The risk threshold may then be set by the physician, the clinic, or even a government regulatory agency to address only the risk that is determined to be an issue. Risk analysis rules 70 may include instructions defining the risk levels, characteristics used in determining each risk level, and any other instructions or rules defining the function of risk analysis module 68 described herein. In some examples, risk analysis module 68 may determine the risk level of a copy-paste passage by determining the percentage of a text passage that is identical to a text passage from another medical document. For example, risk analysis module 68 may determine the percentage of the text in a region (which may be a restricted region) of the medical document that is identical to text in the same (or different) region (which may or may not be a restricted region) of another medical document. Higher percentages of identical text may indicate that the copy-paste passage is of higher risk. In one example, risk analysis module 68 may determine that a copy-paste passage that is greater than 90 percent identical to another text passage is high risk. In another example, risk analysis module 68 may determine different risk levels based on different thresholds of percent identical text. A copy-paste passage over 80 percent identical may indicate a medium risk level and a copy-paste passage over 90 percent identical may indicate a high risk level. In some examples, a copy-paste passage present within a region that has less than the identical percentage threshold may indicate that the copy-paste passage is a low risk passage, whereas a copy-paste passage present within a region that has a greater than the identical percentage threshold may indicate that the copy-paste passage is a high risk.

The magnitude of the risk level may be determined by characteristics of each copy-paste passage. The characteristics may include the locations of the copy-paste passage, content of the copy-paste passage itself, or the relation between the content of the copy-paste passage and other content within the medical document. For example, the source and/or destination of a copy-paste passage may be used as a characteristic to determine the risk level of the copy-paste passage. As discussed above, a medical document may include different regions such as a patient background and history region, symptoms region, diagnosis region, treatment region, and/or additional regions depending on the type of medical document. The text in each of these regions of one medical document may be more or less applicable to regions of another medical document. In this manner, one or more regions may be classified as restricted regions that typically include information specific to the patient encounter of that particular medical document. For example, copying text from a background region from one medical document and pasting the text into the background region of a new medical document may pose low to no risk that the pasted text can adversely affect patient treatment or billing activities. However, copying text from a laboratory region of one medical document and pasting that text into the laboratory region of a new medical document may pose a high risk that the pasted text includes information not accurate for the patient encounter of the new medical document.

In other words, the restricted region may include medical information typically different between different patient encounters. In some examples, only one of the source region or destination region may need to be restricted to pose a high risk of error. Copying text passages from one of these restricted regions of a previously generated medical document, and/or pasting copied text passages into a restricted of a new medical document, may increase the risk that the new medical document includes inaccurate information for the patient encounter for which the medical document is describing. Risk analysis module 68 may thus be configured to determine a high risk level exceeding the risk threshold for the copy-paste passage that has been at least one of copied from a restricted region of a previously generated medical document or pasted into a restricted region of the new medical document.

In addition, or alternative to, restricted regions, risk analysis module 68 may determine high risk levels for copy-paste passages containing a text string that is typically different between different patient encounters. These “risky” test strings may include words typically used to describe current patient conditions and/or numbers identifying current values of items such as patient lab reports, vital signs, or objective patient feedback. Server 22 may utilize natural language processing (NLP) techniques to identify these risky test strings and/or key words that typically precede or are included in the risky text strings of the copy-paste passages.

Risk analysis module 68 may also determine risk levels of copy-paste passages based on incompatibilities within the new medical document to which the copy-paste passages have been added. In other words, risk analysis module 68 may utilize NLP or other techniques to identify when the copy-paste passages include information that is incompatible with other passages within the same medical document. For example, risk analysis module 68 may determine that information is incompatible when there are temporal issues with the text of the copy-paste passage, such as when the copy-paste passage includes a different grammatical tense than text of the other passages in the medical document. A copy-paste passage using past tense may be incompatible when the rest of the medical document uses present tense, as one example. As another example, risk analysis module 68 may determine that the information of the copy-paste passage is in direct conflict with information of the other passages (e.g., the copy-paste passage states the patient is not in pain and another passage states the patient is in pain). In another example, risk analysis module 68 may determine that the information of the copy-paste passage contains subject matter inconsistent with subject matter of the other passages (e.g., a term or phrase within the copy-paste passage is not typically present in conjunction with another term or phrase within a different passage of the medical document). An example of inconsistent subject matter may be the co-occurrence of certain terms or phrases within the medical document. If risk analysis module 68 determines that two or more terms or phrases are contained within the medical document and such occurrence is common, risk analysis module 68 may determine that the co-occurrence of the terms or phrases may have low risk of error. However, if risk analysis module 68 determines that two or more terms or phrases of a medical document are not commonly found together (e.g., a diagnosis of a laceration and a treatment of aspirin that would thin the blood and prevent wound healing), risk analysis module 68 may determine that the co-occurrence of the terms or phrases have high risk of error.

Risk analysis module 68 may determine a high risk level exceeding the risk threshold for the copy-paste passage that contains information incompatible with other passages of the new medical document. Alternatively, risk analysis module 68 may assign different elevated risk levels for each respective characteristic described above. In some examples, risk analysis module 68 may increase the risk level for each of the characteristics a copy-paste passage includes. For example, a copy-paste passage copied from a restricted region of a medical document and includes subject matter inconsistent with subject matter of another passage in the medical document to which the copy-paste passage is pasted may have a higher risk level than a copy-paste passage that is only copied from a restricted region of a medical document.

NLP module 60 may perform natural language processing on previously generated medical documents and new medical documents understand the content of passages within each medical document. For example, the natural language processing may be performed by NLP module 60 using rules and/or algorithms stored in NLP rules 62. NLP module 60 may determine context and content of text so that risk analysis module 68 can determine whether or not there are any inconsistencies between the content of a copy-paste passage and other passages in the medical document. NLP module 60 may also be used to determine the grammatical tense of a copy-paste passage and/or the subject matter of the copy-paste passage. Alternatively, statistical learning techniques may be employed to identify risky content of copy-paste passages. In this manner, risk analysis module 68 may employ NLP module 60 when needed, or alternatively include NLP module 60 as part of risk analysis module 68.

Risk analysis module 68, or another learning module, may be configured to employ one or more learning algorithms to classify regions of a medical document as restricted or not restricted, determine whether or not a text string is “risky” or includes some risk, and/or identify when content is incompatible with other content of a medical document. For example, risk analysis module 68 may employ machine learning techniques to track the text and feedback from a human expert monitoring various medical documents and generate rules regarding which text may be likely to cause adverse outcomes for the patient or billing issues. In some examples, risk analysis module 68 may monitor changes made by a physician to any copy-paste passages to identify which portions of the passages are changed and how the passages are changes. Risk analysis module 68 may thus learn which passages contain risk of an error to the medical documentation process.

In an alternative example, risk analysis module 68 and copy-paste detection module 64 may operate in a different order to determine risk of copy-paste passages. For example, risk analysis module 68 may analyze a new medical document for any restricted regions and the regions other medical documents. For each of the restricted regions of the new medical document, copy-paste detection module 64 may determine the percentage of text that is identical to any other region of the other medical documents. Copy-paste detection module 64 may also determine the percentage of text in any region of the new medical document that is identical to restricted regions from the other medical documents. Risk analysis module 68 may then indicate any restricted regions of the new medical document that have identical text to other medical documents, and in some examples, any regions of the new medical document that have identical text to restricted regions of the other medical documents. Risk analysis module 68 may order, for display, the passages with some identical text according to the percentage of identical text (e.g., higher percentages first). Risk analysis module 68 may implement a risk threshold for determining which regions have low risk and which regions have high risk. For example, risk analysis module 68 may determine that only regions with identical text above an 80 percent risk threshold are high risk level copy-paste passages. Only high risk passages may be output for display to a user. Other risk thresholds, or multiple risk thresholds for respective risk levels, may be used instead (e.g., risk thresholds of 70 percent, 85 percent, 90 percent, 95 percent, or 99 percent).

The risk levels determined by risk analysis module 68 may be transmitted to interface module 72 for generation of indications of copy-paste passages having a risk level exceeding the risk threshold. Interface module 72 may follow the instructions in interface information 74 to output indications of any copy-paste passages having a risk level exceeding the risk threshold for display to the user (e.g., the physician or compliance officer). Interface module 72 may output, via communication interface 56 and network 20, this indication to client computing device 12 via network 20 for display at a display device of client computing device 12. In one example, interface module 72 may output the indication of the copy-paste passage as highlighted text within the medical document. The highlighted text may flag the text as a copy-paste passage that requires attention to ensure that the copy-paste passage does not include inaccurate information with respect to the patient encounter described by the medical document. In another example, interface module 72 may underline the copy-paste passage, change the color of the text within the copy-paste passage, insert arrows or brackets to identify the copy-paste passages, or provide any other such indication. In some examples, interface module 72 may indicate a smaller portion of the copy-paste passage that triggered the high risk level instead of the entire copy-paste passage. In this manner, server 22 may quickly identify the potential inaccurate information of the copy-paste passage for copy-paste passages that can include hundreds or even thousands of words across many pages of the medical document.

As described herein, the inaccurate information of a copy-paste passage may include information specific to the previously generated medical document from which the passage was copied instead of being specific to the new medical document into which the passage was pasted. In this manner, the information of the copy-paste passage may be correct in the context of the medical document from which the passage was copied, but the information becomes inaccurate because it is being used to erroneously describe a different patient encounter for the new medical document into which the copy-paste passage was pasted. In some examples, the new medical document may be related to one patient encounter and a previously generated medical document may be related to a different patient encounter for the same patient. In other examples, the new medical document may be related to a patient encounter for one patient whereas the previously generated medical document may be related to a patient encounter for a different patient. In this manner, copy-paste passages may occur between medical documents for the same patient and/or between medical documents for different patients.

Once interface module 72 has output the indication of one or more copy-paste passages, processor 50 may receive user input addressing the copy-paste passages via a user interface provided by client computing device 12. For example, interface module 72 may be configured to receive, from a medical professional associated with the patient encounter (e.g., the patient's physician), user input that either confirms the copy-paste passage is correct or modifies, in response to correction user input, at least a portion of the copy-paste passage to remove any inaccuracies. In other examples, in response to a prompt from interface module 72 to confirm or correct the copy-paste passage, the user may access the copy-paste passage within the patient's EHR and correct a portion of the copy-paste passage if necessary. In this manner, interface module 72 may provide an indication that a correction to the medical document should take place or even a link to the actual medical document without interface module 72 directly modifying the medical document. Responsive to receiving the user input addressing the identified copy-paste passages (or determining that the user has addressed the high risk copy-paste passage via another interface), interface module 72 may remove the indication of the copy-paste passages for which the risk level exceeds the risk threshold. In this manner, processor 50 may provide indications of copy-paste passages as an interactive process in which interface module 72 flags, from risk analysis module 68, potentially risky copy-paste passages and removes the flags when the risk of the copy-paste passages no longer are present. In this manner, processor 50 may analyze modifications to the copy-paste passages and check if the modifications eliminate the one or more inaccuracies of the copy-paste passage. In some examples, in response to determining that the user has modified at least a portion of a copy-paste passage, processor 50 may perform another iteration of the identification of copy-paste passages and risk analysis on the modified copy-paste passages to ensure the physician has not merely copied additional text from another medical document and/or the resulting passage is still not a high risk copy-paste passage.

In some examples, interface module 72 may provide various functionality to review generated medical documents for copy-paste passages and potential errors, such as the review of recently generated medical documents. This review may occur days, weeks, months, or even longer after the medical documents have been generated. Interface module 72 may provide this functionality to authors of the medical documents (i.e., medical professionals) and/or non-authors (e.g., compliance officers of the healthcare organization). For example, interface module 72 may be configured to present recently generated medical documents (e.g., new documents generated within a recent period of time) that may contain copy-paste passages to a compliance officer. This alert of copy-paste passages may be performed automatically by interface module 72 in response to detection of such passages (e.g., high risk passages) or upon request by the user. In some examples, interface module 72 may allow the user to sort the recent medical documents by one or more criteria, such as the risk level of each medical document, the risk level of each copy-paste passage of the recent medical documents, the length of each recent medical documents, high risk copy-paste passages that have not been corrected by a medical professions, high risk copy-paste passages that have been corrected by a medical professional, the author of the recent medical documents, the department of the authoring medical professional, or any other such criteria.

FIG. 3 is a block diagram illustrating a stand-alone computing device configured to identify and analyze copy-paste passages of a medical document. Computing device 100 may be substantially similar to server 22 and repository 24 of FIG. 2. However, computing device 100 may be a stand-alone computing device configured to identify copy-paste passages and determine a risk level of the passages. Computing device 100 may be configured as a workstation, desktop computing device, notebook computer, tablet computer, mobile computing device, or any other suitable computing device or collection of computing devices.

As shown in FIG. 3, computing device 100 may include processor 110, one or more input devices 114, one or more output devices 116, communication interface 112, and one or more storage devices 120, similar to the components of server computing device 22 of FIG. 2. Computing device 100 may also include communication channels 118 (e.g., a system bus) that allows data flow between two or more components of computing device 100, such as between processor 110 and storage devices 120. Computing device 100 also includes one or more storage devices 120, such as a memory, that stores information such as instructions for performing the processes described herein and data such as medical documents for a patient and algorithms for identifying copy-paste passages, determining a risk level of the copy-paste passages, and/or receiving user input addressing identified copy-paste passages.

Storage devices 120 may include data for one or more modules and information related to the copy-paste passage identification and risk determination described herein. For example, storage devices 120 may include NLP module 124, copy-paste module 128, risk analysis module 132, and interface module 136, similar to the modules described with respect to repository 24 of FIG. 2. Storage devices 120 may also include information such as NLP rules 126, detection rules 130, risk analysis rules 134, interface information 138, and Electronic Health Records (EHR) 140, similar to the information described as stored in repository 24.

The information and modules of storage devices 120 of computing device 100 may be specific to a healthcare entity that employs computing device 100 to monitor the use of copy-paste passages in the medical documents generated by healthcare professionals (e.g., physicians and/or nurses) associated with the healthcare entity. For example, detection rules 130 may contain a specific instruction set that is used identify copy-paste passages. In any case, computing device 100 may be configured to perform any of the processes and tasks described herein and with respect to server 22 and repository 24. Storage devices 120 may also include user interface module 122, which may provide a user interface for a user via input devices 114 and output devices 116.

In some examples, input devices 114 may include one or more scanners or other devices configured to convert paper documents into electronic clinical documents that can be analyzed by computing device 100. In other examples, communication interface 112 may receive electronic clinical documents from a repository or individual clinician device on which clinical documentation are initially generated. Communication interface 112 may thus send and receive information via a private or public network.

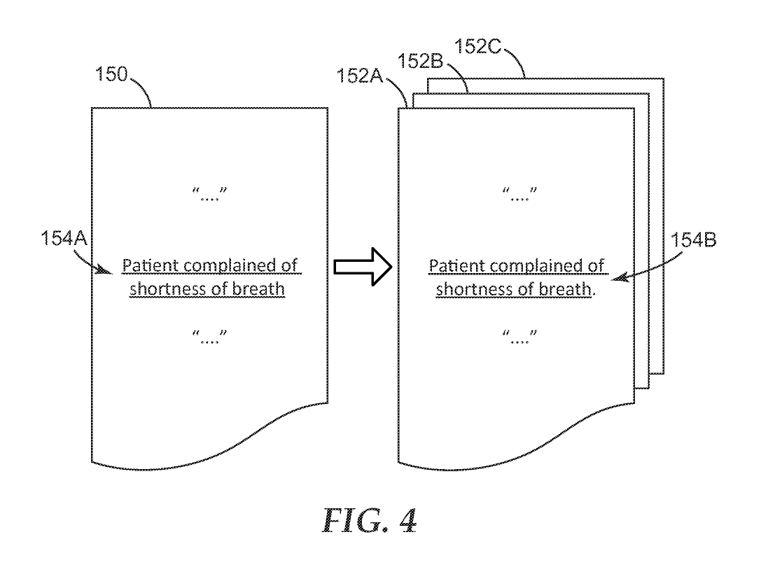

FIG. 4 is an illustration of an example medical document 150 with a copy-paste passage 154A identified from another medical document 152A. Server 22 of FIG. 2 will be described with respect to an example technique for identifying copy-paste passages. As shown in FIG. 4, copy-paste detection module 64 may receive new medical document 150 and analyze the content of medical document 150 and medical documents 152A, 152B, and 152D (collectively “medical documents 152”). Copy-paste detection module 64 may then compare the text of medical document 150 to the text of medical documents 152. Copy-paste detection module 64 may determine that text string 154A of medical document 150 (e.g., “Patient complained of shortness of breath”) is identical to text string 154B of medical document 152A. Therefore, copy-paste detection module 64 may determine that medical document 150 has been generated using a portion of the text of medical document 152A.

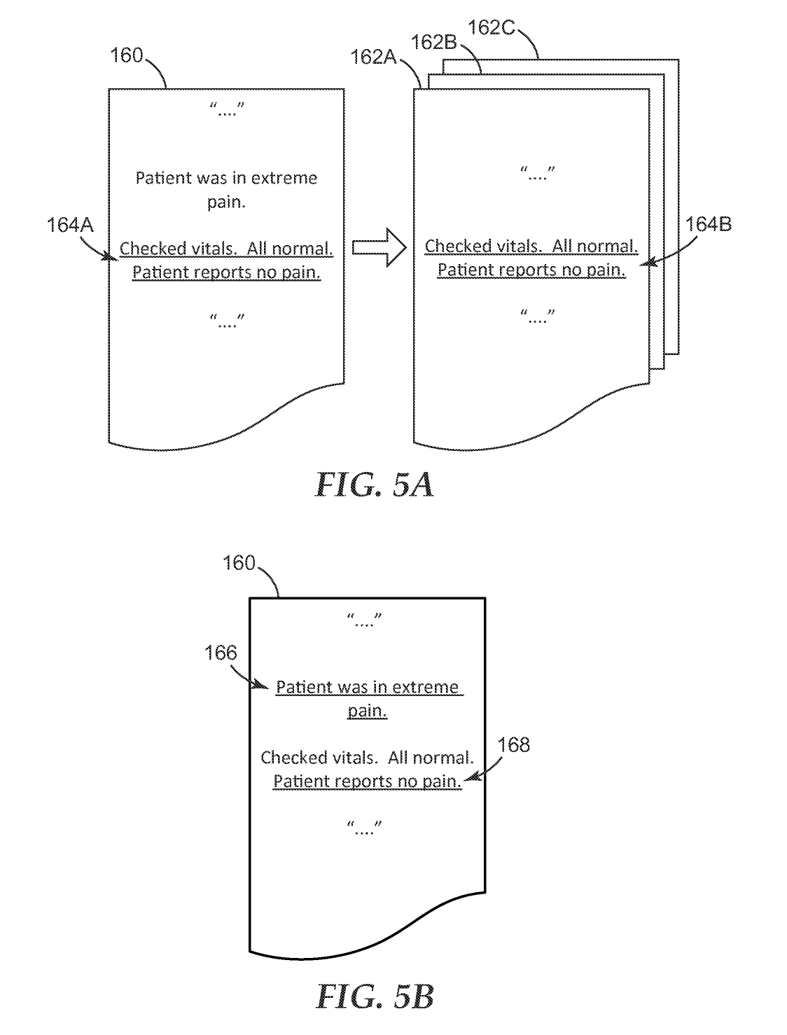

FIG. 5A is an illustration of an example medical document 160 with a copy-paste passage from another medical document 162A and FIG. 5B is an illustration of example medical document 160 with copy-paste passage 168 incompatible with another passage 166 of the same medical document 160. Server 22 of FIG. 2 will be described with respect to an example technique for identifying copy-paste passages and determining risk levels for the copy-paste passages. As shown in FIG. 5A, copy-paste detection module 64 may receive new medical document 160 and analyze the content of medical document 160 and medical documents 162A, 162B, and 162D (collectively “medical documents 162”). Copy-paste detection module 64 may then compare the text of medical document 160 to the text of medical documents 162. Copy-paste detection module 64 may determine that text string 164A of medical document 160 (e.g., “Checked vitals. All normal. Patient reports no pain.”) is identical to text string 164B of medical document 162A. Text strings 164A and 164B include just some of the text that each of respective medical documents 160 and 162A may include. Therefore, copy-paste detection module 64 may determine that medical document 160 has been generated using a portion of the text of medical document 162A and that text string 164A is a copy-paste passage.

However, risk analysis module 68 may still determine the risk level of text string 164A. Risk analysis module 68 may analyze medical document 160 and/or medical document 162A for characteristics of text string 164 that may indicate the text string is a high risk or low risk copy-paste passage. As shown in FIG. 5B, risk analysis module 68 has identified an incompatibility within medical document 160. Risk analysis module 68 may leverage NLP module 60, for example, to compare the meaning of different passages within medical documents. Specifically, risk analysis module 68 has determined that an intradocument conflict exists with a portion of text string 164. Portion 168 of the copy-paste passage states that “Patient reports no pain.” However, passage 166 of medical document 160 states that “Patient was in extreme pain.” These two statements in portion 168 and passage 166 are in direct conflict regarding the pain experienced by the patient during the patient encounter for which medical document 160 was generated. For this reason, risk analysis module 68 may assign a high risk level to the copy-paste passage that is text string 164A.

Although FIG. 5B is provided to illustrate one characteristic for determining a high risk level for a copy-paste passage, other high risk characteristics may also be present that would cause risk analysis module 68 to assign a high or elevated risk level. For example, risk analysis module 68 may determine that the grammatical tense of portion 168 of the copy-paste passage is inconsistent with the grammatical tense of passage 166. As another example, text string 164A may have been copied from a restricted region of medical document 162A and/or pasted into a restricted region of medical document 160. Any of these characteristics of the copy-paste passage may support a high risk level. In some examples, risk analysis module 68 may add up each high risk characteristic for a copy-paste passage to determine many different risk levels. In some examples, the characteristics may be weighted, since some characteristics may indicate a greater likelihood that the copy-paste passage includes inaccurate information for the medical document.

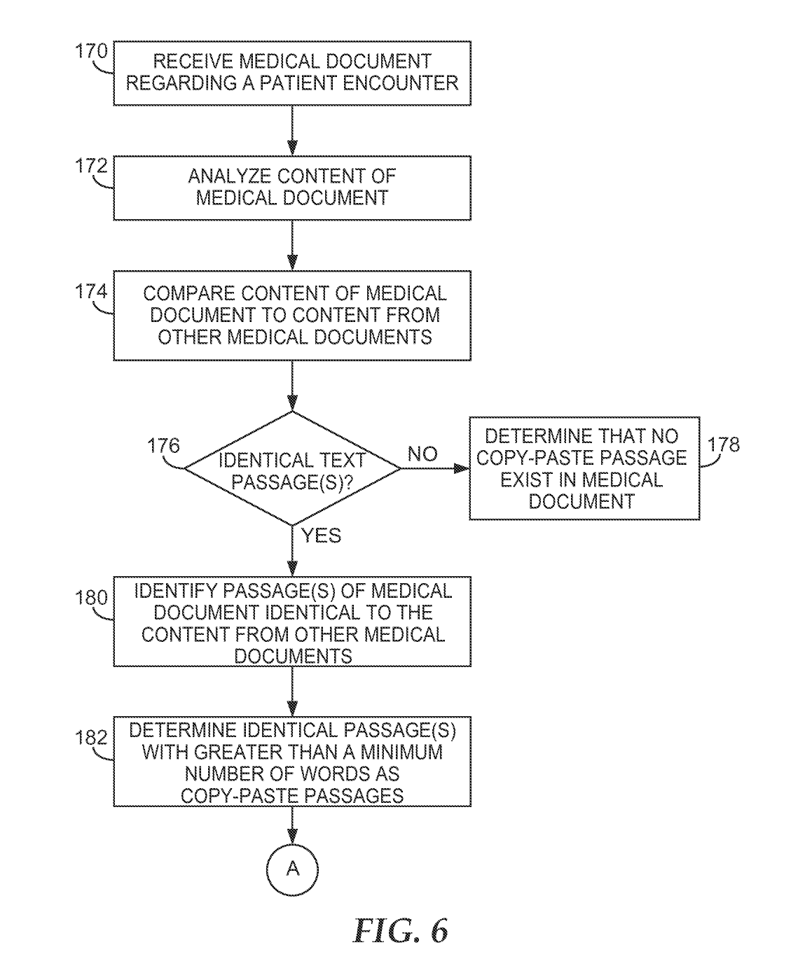

FIG. 6 is a flow diagram illustrating an example workflow for analyzing medical documents and determining one or more copy-paste passages in a medical document. FIG. 6 will be described from the perspective of sever 22 and repository 24 of FIGS. 1 and 2, although computing device 100 of FIG. 3, any other computing devices or systems, or any combination thereof, may be used in other examples. As shown in FIG. 6, processor 50 may be configured to receive a new medical document regarding a patient encounter (170). The new medical document is described as “new” in the sense that it could have been recently generated by the physician (e.g., received in real-time as soon as the document was saved or submitted) or “new” in the sense that it has been generated more recently than other medical documents.

Processor 50 may then execute copy-paste detection module 64 to analyze the content of the new medical document (172) and compare the content of the new medical document to the content from other medical documents generated prior to the new medical document (174). The other medical documents may also be received by processor 50 from EHR 76 or an external storage device. In some examples, NLP module 60 may analyze the content of the new medical document prior to the comparison step. In this manner, NLP module 60 may also analyze the other medical documents during step 172 or the other medical documents may have been previously analyzed. The comparison of content may include determining any identical text passages. Identical text passages may need to include identical text and also identical punctuation and formatting that would be evidence of a passage that has been copied and pasted. Alternatively, identical text passages may have some differences in formatting or punctuation that may have been lost in a paste function that does not retain all formatting from the copied medical document. In this manner, processing the medical documents for natural language or some other statistical processing may be beneficial when copied and pasted passages are not exactly identical in all respects.

If copy-paste detection module 64 determines that no text passages of the new medical document are identical (“NO” branch of block 176), copy-paste detection module 64 may determine that no copy-paste passages exist in the new medical document (178). If copy-paste detection module 64 determines that one or more text passages of the new medical document are identical (“YES” branch of block 176), copy-paste detection module 64 identifies the passages of the new medical document that are identical to the content of one or more other medical documents (180). In order to limit very small text passages from being identified as copy-paste passages when they are instead just commonly used phrases, copy-paste detection module 64 may determine any of the identical text passages with greater than a minimum number of words as copy-paste passages (182).

The minimum number of words may be set by an administrator responsible for the system described herein or the manufacturer of the system. Alternatively, copy-paste detection module 64 may employ learning functionality that identifies commonly used phrases over time. The learning function may incorporate feedback from users confirming that certain phrases are correct and not actually copy-paste passages. In this manner, copy-paste detection module 64 may track this feedback and determine a minimum number of words typical of actual copy-paste passages. In addition, or alternatively, copy-paste detection module 64 may order the identical passages by decreasing number of words or characters in the passages. Copy-paste detection module 64 may identify those passages with a greater number of words and/or characters as copy-paste passages. Detection rules 66 may store instructions on how many copy-paste passages should be selected. In other examples, copy-paste detection module 64 may determine that any identical text passages are copy-paste passages, regardless of the length of the passage. Copy-paste detection module 64 may then transmit the identified copy-paste passages to risk analysis module 68 for further processing.

In alternative examples, copy-paste detection module 64 may determine that a text passage has been copied and pasted by directly tracking copy and/or paste functionality at the text entry level (e.g., word processing application or operating system function) when generating the medical document. In this manner, copy-paste detection module 64 may determine that text has been copied and pasted without comparing content of medical documents.

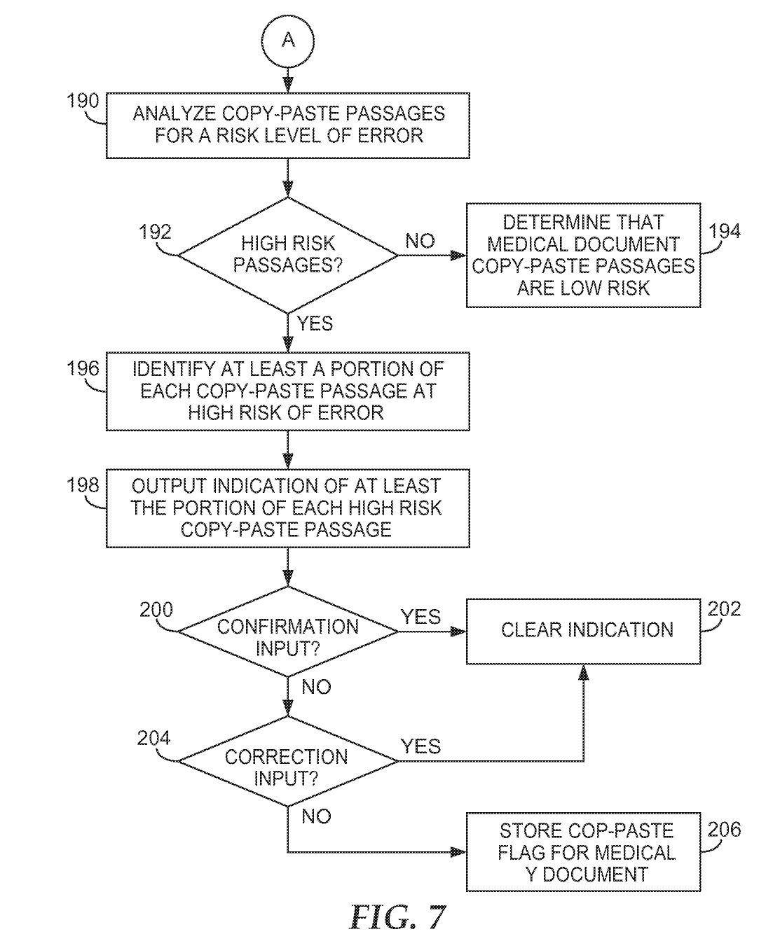

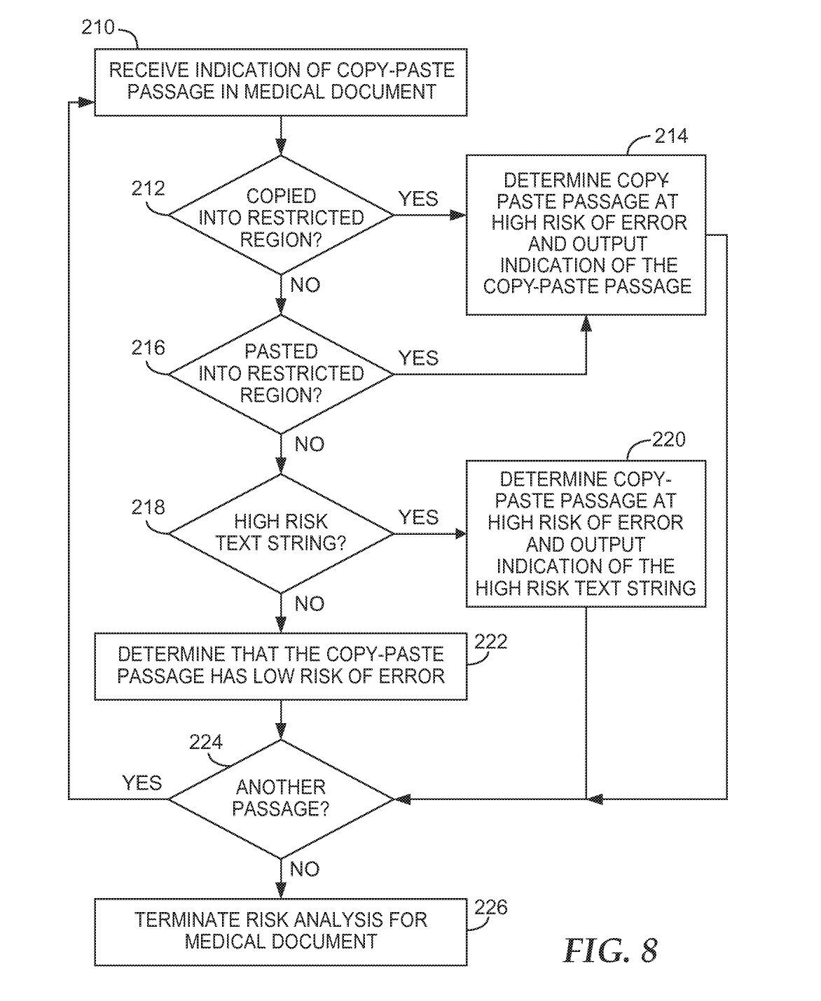

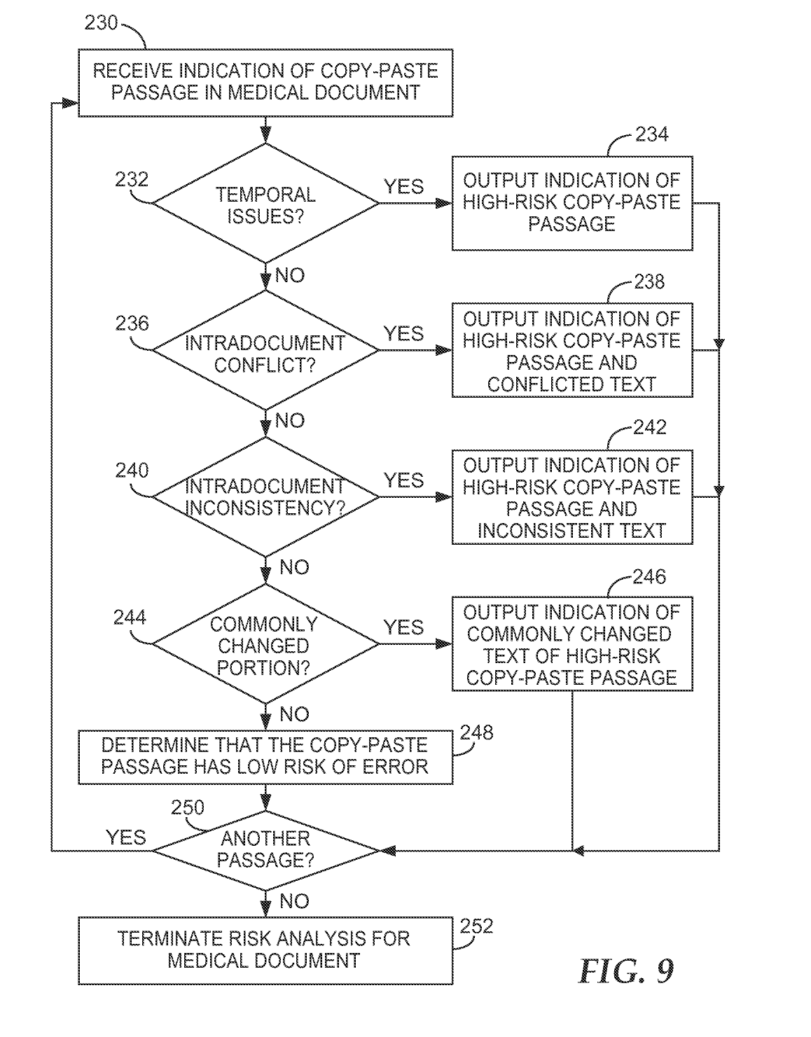

FIG. 7 is a flow diagram illustrating an example technique for determining a risk level for each copy-paste passage of a medical document. FIG. 7 may be a continuation from step 182 of FIG. 6 and will similarly be described from the perspective of sever 22 and repository 24 of FIGS. 1 and 2, although computing device 100 of FIG. 3, any other computing devices or systems, or any combination thereof, may be used in other examples. As shown in FIG. 7, risk analysis module 68 may receive the copy-paste passages from copy-paste detection module 64 and analyze the copy-paste passages for a risk level of error that may occur due to inaccuracies within the copy-paste passage with respect to the patient encounter associated with the new medical document (190). The risk analysis may evaluate the presence of many different types of characteristics associated with copy-paste passages, such as where the copy-paste passage was copied from and if the copy-paste passage is incompatible with other passages within the new medical document. These different characteristics, or risk factors, are described further in FIGS. 8 and 9.

FIG. 7 will be described with a risk level of either high risk or low risk. However, risk analysis module 68 may determine many different risk levels to provide a more striated indication of risk for each of the copy-paste passages. If risk analysis module 68 determines that none of the copy-paste passages have a high risk level exceeding a risk threshold (“NO” branch of block 192), risk analysis module 68 determines that the copy-paste passages of the new medical document are all of a low risk level (194). If risk analysis module 68 determines that one or more of the copy-paste passages have a high risk level exceeding the risk threshold (“YES” branch of block 192), risk analysis module 68 identifies at least a portion of each copy-paste passage having the high risk of error (196). Although risk analysis module 68 may identify the entire copy-paste passage when it has a high risk level, risk analysis module 68 may more precisely identify only the high risk portion of the copy-paste passage to allow more efficient user identification of the inaccurate text.

Interface module 72 may then output an indication of at least a portion of each of the high risk copy-paste passages (198). The indication may include highlighting the high risk portion, underlining the high risk portion, changing the color of the high risk text, bracketing the high risk portion, inserting arrows before and/or after the high risk portion, or any other visual indication. In some examples, the indication may also or alternatively include audible and/or haptic feedback regarding the high risk portion of the copy-paste passage. For example, an automated voice may verbally instruct the user of high risk portion or a vibration may be generated by interface module 72 when the user “mouses over” or “hovers over” the high risk portion. Interface module 72 may also generate a list of high risk copy-paste passages that may include the text of the passage, the location of the passage within the medical document, or even a hyperlink that, when selected, brings the associated high risk passage in view for the user.

Copy-paste detection module 64, risk analysis module 68, and interface module 72 may operate in real-time to output the indication of at least the portion of the copy-paste passage as the user (e.g., the physician) is generating the new medical document. For example, server 22 may receive an updated new medical document any time that the medical document is saved or submitted, and server 22 may return any high risk copy-paste passages immediately so that the user can correct the copy-paste passage as the medical document is created. Alternatively, copy-paste detection module 64, risk analysis module 68, and interface module 72 may operate as a post-processing quality control algorithm to search for already generated medical documents that may include high risk copy-paste passages.

If interface module 72 receives a user input confirming that a copy-paste passage is correct (“YES” branch of block 200), interface module 72 may remove or clear the indication of the copy-paste passage as it has been addressed by the user (202). If no confirmation input has been received (“NO” branch of block 200), interface module may check for any correcting input received (204). If interface module 72 receives an indication of user input correcting or otherwise modifying a copy-paste passage (“YES” branch of block 204), interface module 72 may remove or clear the indication of the copy-paste passage as it has been addressed by the user (202). If user interface module 72 has not received a confirmation input or correction input for the copy-paste passage (“NO” branch of block 204), interface module 72 may store a copy-paste flag for the passage in the medical document (206). In some examples, risk analysis module 68 may reevaluate the risk of the copy-paste passage after receiving correction input to ensure that the high risk has indeed been addressed.

Interface module 72 may not actually receive the user input and/or directly modify the copy-paste passage. Instead, interface module 72 may receive an indication of user input indicating that at least a portion of the copy-paste passage will be modified or has been modified (after the user modifies the passage). The user may correct at least a portion of the text of the copy-paste passage via an interface (different from interface module 72) connected to the EHR of the patient. Interface module 72 may provide a link, selectable by the user, that brings up the medical document from the EHR for correction. In some examples, processor 50 may receive a notification that the medical document has been modified, and responsive to receiving the notification, processor 50 may again analyze the medical document for presence of the copy-paste passage, or a new copy-paste passage, before clearing the indication of the copy-paste passage.

FIG. 8 is a flow diagram illustrating an example technique for determining a risk level based on general risk factors. FIG. 8 is described from the perspective of sever 22 and repository 24 of FIGS. 1 and 2, although computing device 100 of FIG. 3, any other computing devices or systems, or any combination thereof, may be used in other examples. FIG. 8 may provide more detailed examples of determining high risk copy-paste passages. In other words, the steps of FIG. 8 may be used in place of steps 190, 192, 194, and 196 of FIG. 7. The risk analysis of FIG. 8 may be referred to as analyzing for general risk that the copy-paste passage includes inaccurate information because the analysis may look for risk factors associated with mechanical characteristics about the passage instead of what the passage is contextually describing.

As shown in FIG. 8, risk analysis module 68 may receive an indication of copy-paste passages in a new medical document (210). If risk analysis module 68 determines that the copy-paste passage has been copied from a restricted region of another medical document (“YES” branch of block 212), risk analysis module 68 may determine that the copy-paste passage is at high risk for error and output the indication of the copy-paste passage (214). If risk analysis module 68 determines that the copy-paste passage was not copied from a restricted region of another medical document (“NO” branch of block 212), but the copy-paste passage was pasted into a restricted region of the new medical document (“YES” branch of block 216), risk analysis module 68 may also determine that the copy-paste passage is at high risk for error and output the indication of the copy-paste passage (214). A restricted region of a medical document may be, for example, a region that typically includes information specific to the patient encounter for this the medical document was created. For example, restricted regions may include regions associated with patient symptoms, lab data, diagnoses, and/or procedures performed.

If risk analysis module 68 determines that the copy-paste passage was not pasted into a restricted region of the new medical document (“NO” branch of block 216), risk analysis module 68 may determine if the copy-paste passage includes a high risk text string (218). A high risk text string may include text that includes numbers or has been previously identified during a learning mode as a text string that can include inaccurate information. If risk analysis module 68 determines that the copy-paste passage includes a high risk text string (“YES” branch of block 218), risk analysis module 68 may determine that the copy-paste passage is at high risk for error and output the indication of the copy-paste passage (220). After risk analysis module 68 determines that the copy-paste passage is high risk, risk analysis module 68 may look for another copy-paste passage to analyze (210).

If risk analysis module 68 determines that the copy-paste passage does not includes a high risk text string (“NO” branch of block 218), risk analysis module 68 determines that the copy-paste passage has a low risk or error in the new medical document (222). If risk analysis module 68 identifies another copy-paste passage to analyze (“YES” branch of block 224), risk analysis module 68 may receive the next copy-paste passage (210). If risk analysis module 68 does not identify any further copy-paste passages in the new medical document (“NO” branch of block 224), risk analysis module 68 may terminate the risk analysis for the new medical document (226).

In other examples, risk analysis module 68 may process the copy-paste passage for each characteristic (e.g., steps 212, 216, and 218) in a different order. In alternative examples, risk analysis module 68 may analyze each copy-paste passage for the presence of all characteristics. In other words, even if risk analysis module 68 determines that the copy-paste passage has been copied from a restricted region of another medical document, risk analysis module 68 may still determine whether or not the copy-paste was pasted into a restricted region of the new medical document and whether the passage includes a high risk text string. This process of evaluating each characteristic may be more applicable when the risk level is dependent upon how many high risk characteristics the copy-passage has instead of just whether the copy-paste passage has at least one high risk characteristic.

FIG. 9 is a flow diagram illustrating an example technique for determining a risk level based on specific risk factors. FIG. 9 is described from the perspective of sever 22 and repository 24 of FIGS. 1 and 2, although computing device 100 of FIG. 3, any other computing devices or systems, or any combination thereof, may be used in other examples. FIG. 9 may provide more detailed examples of determining high risk copy-paste passages. In other words, the steps of FIG. 9 may be used in place of steps 190, 192, 194, and 196 of FIG. 7. The risk analysis of FIG. 9 may be referred to as analyzing for specific risk that the copy-paste passage includes inaccurate information because the analysis may look for risk factors associated with contextual characteristics about the passage. These contextual characteristics may be the context of the copy-paste passage to other passages within the same medical document (intradocument incompatibilities) or the context of the copy-paste passage with respect to other similar pasted passages common to other medical documents.

As shown in FIG. 9, risk analysis module 68 may receive an indication of copy-paste passages in a new medical document (230). If risk analysis module 68 determines that the copy-paste passage has any temporal issues for the new medical document (“YES” branch of block 232), risk analysis module 68 may determine that the copy-paste passage is at high risk for error and output the indication of the copy-paste passage (234). Temporal issues may include grammatical tense disagreement between the copy-paste passage and another passage of the new medical document.

If risk analysis module 68 determines that the copy-paste passage had no temporal issues (“NO” branch of block 232), risk analysis module 68 may analyze the copy-paste passage for any intradocument conflict, such as actions or statements that directly contradict each other. Such conflicting passages may be a copy-paste passage that indicates the patient was in pain and another passage within the same medical document that indicates the patient is not in pain. If risk analysis module 68 determines that the copy-paste passage has any intradocument conflict (“YES” branch of block 236), risk analysis module 68 may determine that the copy-paste passage is at high risk for error and output the indication of the copy-paste passage and the conflicted text (238).

If risk analysis module 68 determines that the copy-paste passage had no intradocument conflict (“NO” branch of block 236), risk analysis module 68 may analyze the copy-paste passage for any intradocument inconsistencies, such as the co-occurrence of items that typically are not found together. An example of an intradocument inconsistency is a copy-paste passage that states the patient was treated with aspirin but another passage in the medical document states that the patient had a laceration. In other words, aspirin is a blood thinner and typically not prescribed with lacerations. If risk analysis module 68 determines that the copy-paste passage has any intradocument inconsistency (“YES” branch of block 240), risk analysis module 68 may determine that the copy-paste passage is at high risk for error and output the indication of the copy-paste passage and the inconsistent text (242).

If risk analysis module 68 determines that the copy-paste passage had no intradocument inconsistency (“NO” branch of block 240), risk analysis module 68 may analyze the copy-paste passage for any commonly changed portion of the copy-paste passage (244). In some situations, physicians may copy text that includes only a small portion that needs to be updated for the patient at issue. For example, the physician may copy a text passage describing a routine foot examination that includes a measurement of the patient's foot that will need to be modified to be specific for that patient. Risk analysis module 68 may be configured to identify such commonly changed portions based on previous feedback from physicians or repeated change of that particular portion of the same pasted text block. If risk analysis module 68 determines that the copy-paste passage has any commonly changed portions (“YES” branch of block 244), risk analysis module 68 may determine that the copy-paste passage is at high risk for error and output the indication of the commonly changed text of the high risk copy-paste passage (246). After risk analysis module 68 determines that the copy-paste passage is high risk, risk analysis module 68 may look for another copy-paste passage to analyze (250).

If risk analysis module 68 determines that the copy-paste passage does not include a commonly changed portion (“NO” branch of block 244), risk analysis module 68 determines that the copy-paste passage has a low risk or error in the new medical document (248). If risk analysis module 68 identifies another copy-paste passage to analyze (“YES” branch of block 250), risk analysis module 68 may receive the next copy-paste passage (230). If risk analysis module 68 does not identify any further copy-paste passages in the new medical document (“NO” branch of block 250), risk analysis module 68 may terminate the risk analysis for the new medical document (252).

In other examples, risk analysis module 68 may process the copy-paste passage for each characteristic (e.g., steps 232, 236, 240, and 244) in a different order. In alternative examples, risk analysis module 68 may analyze each copy-paste passage for the presence of all characteristics. In other words, even if risk analysis module 68 determines that the copy-paste passage has temporal issues, risk analysis module 68 may still determine whether or not the copy-paste is at risk for any of the other high risk features. This process of evaluating each characteristic may be more applicable when the risk level is dependent upon how many high risk characteristics the copy-passage has instead of just whether the copy-paste passage has at least one high risk characteristic.

Risk analysis module 68 may combine the processes of FIGS. 8 and 9 to analyze each copy-paste passage for any potentially high risk characteristic. In this manner, risk analysis module 68 may be configured to identify any possible characteristic of a copy-paste passage that could indicate the copy-paste passage is at a high risk to include inaccurate information for the medical document in which the passage is located.

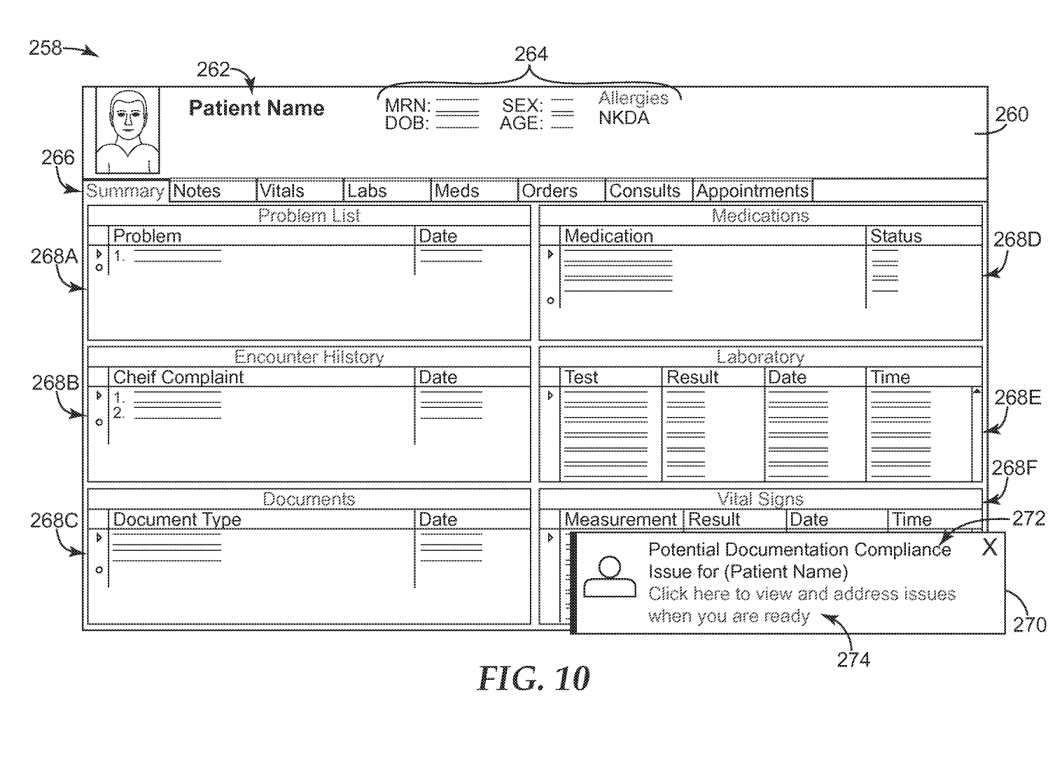

FIG. 10 is an illustration of an example user interface screen 258 that includes notification 270 regarding a copy-paste passage. As shown in FIG. 10, processor 50 of server 22 may output, for display to a user, user interface screen 258. User interface screen 258 may be generated by interface module 72, in some examples. User interface screen 258 includes patient data field 260 and notification 270. Patient data field 260 may include various forms of data regarding the patient. Patient data field 260 may include patient name 262, background information 264, and record tabs 266. Record tabs 266 may include information for different aspects of the patient's record, such as a summary, physician notes, vital signs, lab results, medications, physician orders, consultation information, and appointments.

The “Summary” tab is shown in the example of FIG. 10. The summary tab of record tabs 266 includes problem list 268A that includes any medical problems for the patient, encounter history 268B that may include recorded symptoms of the patient, documents 268C that includes various documents generated regarding the patient, medication list 268D that includes any medications prescribed to the patient, laboratory results 268E regarding various laboratory results for the patient, and vital sign information 268F that may include various vital sign data from one or more patient encounters. Patient data field 260 may include more or less information in other examples.

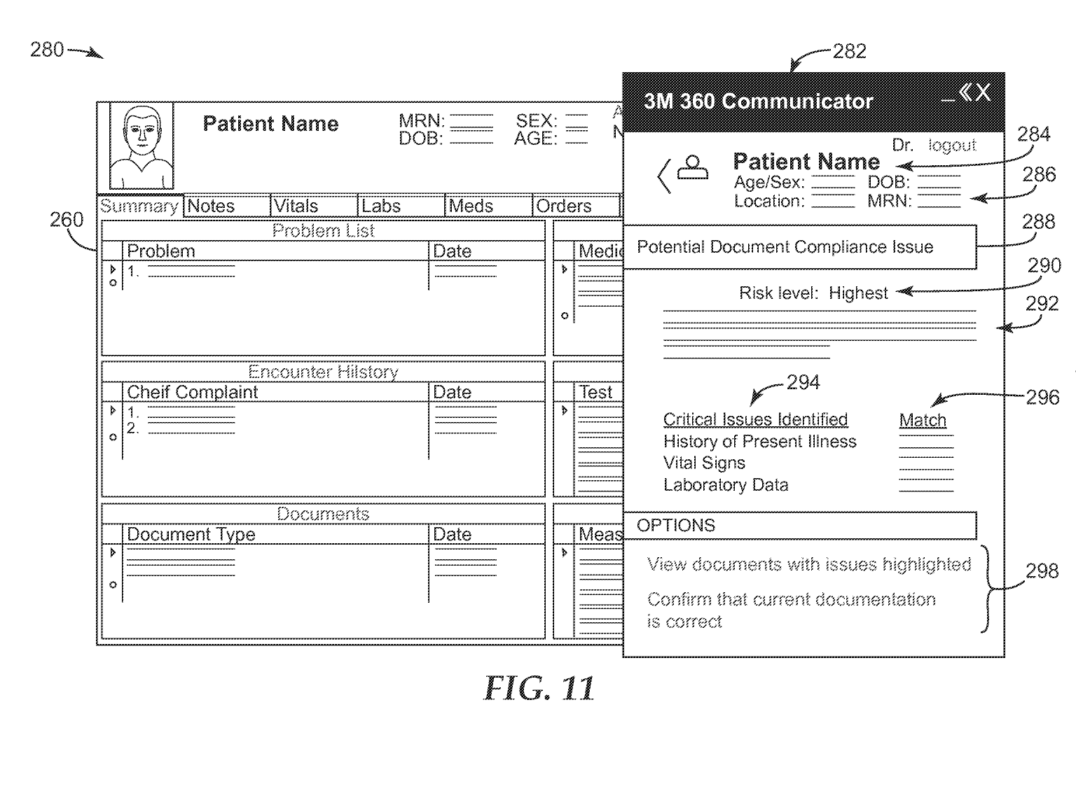

Notification 270 includes information regarding a potential documentation compliance issue for the patient (i.e., one or more high risk copy-paste passages). Notification 270 may be provided as a “pop-up” window over at least a portion of patient data field 260 or adjacent to patient data field 260. In other examples, notification 270 may be generated within a portion of patient data field 260, such as above record tabs 266 or within a new record tab (i.e., next to “Appointments”). In other words, notification 270 may be generated as some visual, audible, haptic, or some combination thereof, indication to the user that a high risk copy-paste passage has been identified. Title line 272 may indicate the subject matter of the notification, such as “Potential Documentation Compliance Issue for (Patient Name)” or even more descriptive information such as “Compliance Issue for Document (Insert date of document)”. Notification 270 may also include action link 274 that, when selected, replaces notification 270 with panel 282 of FIG. 11. Interface module 72 may generate notifications 270 and/or panel 282, for example.

FIG. 11 is an illustration of an example user interface screen 280 that includes panel 282 identifying high risk copy-paste passages. Interface module 72 may generate panel 282 according to interface information 72. As shown in FIG. 11, user interface screen 280 may include patient data field 260 from FIG. 10 in panel 282. Panel 282 may include more detailed information regarding the copy-paste passages with a risk level exceeding the risk threshold or otherwise at risk for error. Panel 282 may include patient name 284, background information 286, panel subject matter indication 288, risk level indicator 290, risk level details 292, copy-paste passages 294, match indicator 296, and options 298.

Panel subject matter indication 288 may state “Potential Document Compliance Issue” or any other textual indication of the type of issue for panel 282. Risk level indicator 290 may provide a risk level for the entire medical document. As shown in FIG. 11, the risk level is indicated as “Highest,” which may indicate one or more copy-paste passages have been identified with a “Highest” risk or that the number of high risk copy-paste passages for the medical document has exceeded a threshold. Risk level details 292 may include a textual description of the risk level. For example, risk level details 292 may include information identifying the new medical document with high risk copy-paste passages and/or the one or more other medical documents from which the passages were copied. In some examples, risk level details 292 may include a percentage of the text in the new medical document that has been determined to have been copied from one or more medical documents. For example, the text of risk level details 292 may include “The patient's current History and Physical Document is an 87% replica of this patient's History and Physical from May 18, 2012.” Risk analysis module 68 may or may not use the percentage replica (percent identical text) of the new medical document to determine the risk level of the medical document.

Copy-paste passages 294 (i.e., the critical issues identified) may include identifiers of each copy-paste passage that has been determined to be of high risk for error. These copy-paste passages may be identified by the region in which they reside, by a number, first few words of the passage, or other indicator that the user can use when referencing the copy-paste passages at a later time. In the example of FIG. 11, copy-paste passages 294 may include “History of Present Illness,” “Vital Signs,” and “Laboratory Data.” Match indicator 296 may include an indicator for each of the copy-paste passages that is outputted, for display, to include a percentage match between the copy-paste passage of the new medical document and a copied portion of the other medical document. Match indicator 296 may include the percent of text that matches within the region or within the identified copy-paste passage. Alternatively, match indicator 296 may include the number of characters, words, or other characteristic of the risk of the copy-paste passage. For example, match indicator 296 may include the risk level for each identified copy-paste passage. The risk level may be selected from high and low risk or a numerical ranking (e.g., a risk level of 10, 9, 8, 7, 6, 5, 4, 3, 2, and 1, with 1 being low risk). Other indications of risk may be used in other examples.

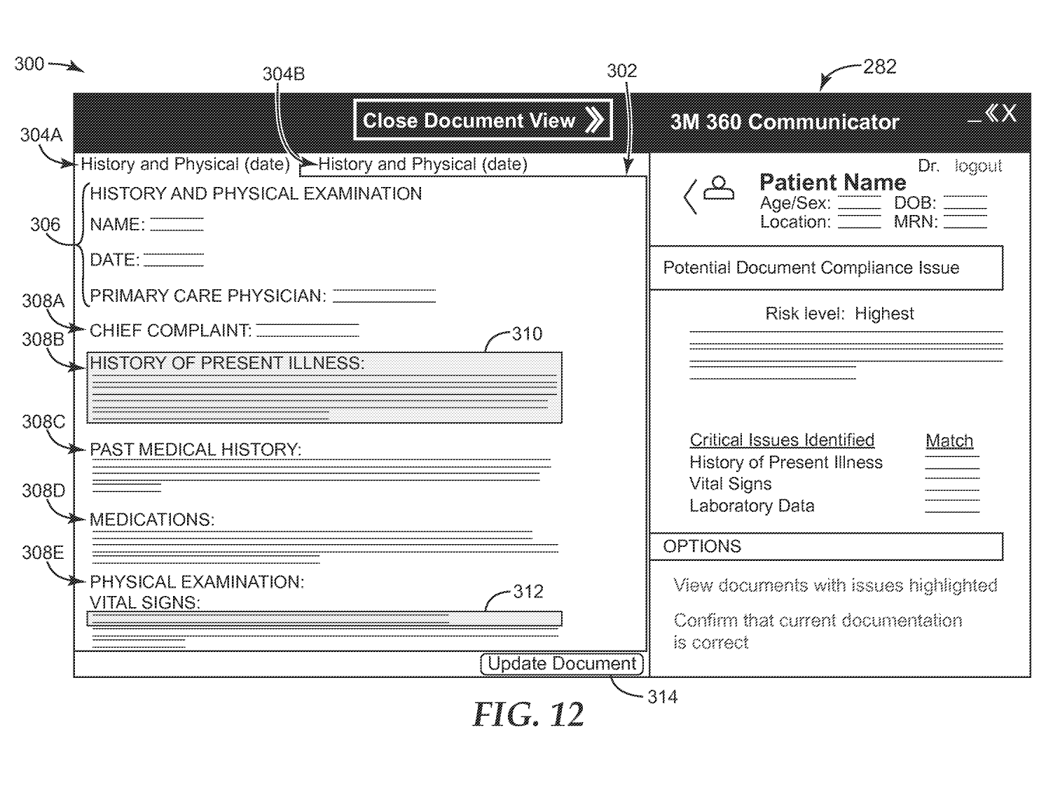

Options 298 include selectable items from which the user can select to address one or more of the copy-pate passages 294. For example, options 298 may include a selectable link to “View documents with issues highlighted” and make corrections to these medical documents in the EHR. Selection of this option may bring the user to user interface screen 300 of FIG. 12. Options 298 may also include a selectable item to “Confirm that current documentation is correct” that, when selected, indicates to interface module 72 that the high risk copy-paste passages are correct and do not contain errors.

FIG. 12 is an illustration of an example user interface screen 300 that includes indications of high risk copy-paste passages in a medical document. Interface module 72 may generate medical document field 302 or request that another interface displays the medical document field 302 from the EHR. As shown in FIG. 12, user interface screen 300 may include panel 282 of FIG. 11 and medical document field 302. Medical document field 302 may include one or more medical documents associated which the determined high risk copy-paste passages. Within medical document field 302, the user may be able to view the copy-paste passages and, in some examples, modify one or more medical documents to correct any inaccurate information associated with the copy-paste passages.

Medical document field 302 may include one or more medical documents. The medical documents may be separated into different tabs, as shown by document tabs 304A and 304B. Selection of one of tabs 304A and 304B may show the selected medical document. In this manner, the user may toggle between two or more medical documents to view to potentially identical text of the copy-paste passages. A medical document may include different regions, such as background region 306, chief complaint region 308A, history of present illness region 308B, past medical history region 308C, medications region 308D, and physical examination region 308E. Additional regions of a medical document not shown in FIG. 12 may include a laboratory data region, procedure region, treatment region, notes region, follow-up region, or any other related information. In some examples, medical documents may include fewer or more regions.

Medical document field 302 may also highlight the copy-paste passages of high risk identified in panel 282. Copy-paste passage 310 (i.e., the History of Present Illness region) is highlighted (shown with a light grey background) to bring the copy-paste passage to the attention of the user. In addition, copy-paste passage 312 (i.e., the Vital Signs section) is highlighted (shown with a light grey background) to bring the copy-paste passage to the attention of the user. Copy-paste passage 310 shows an example entire region (e.g., the History of Present Illness region 308B) that has been highlighted due to a copy-paste passage within the region. Copy-paste passage 310 shows an example where only the portion of the region (e.g., the Physical Examination region 308E) associated with the copy-paste passage (i.e., the vital signs) is highlighted.

As discussed herein, user input may be provided via user interface screen 300 to modify one or more of the medical documents in medical document field 302 to address one or more copy-paste passages. For example, the user may review and modify any text within copy-paste passages 310 or 312 to remove any inaccuracies from those passages of the medical document. When the user is done making corrections, the user may select update document button 314. Responsive to receiving selection of update document button 314, processor 50 or the system in control of the patient's EHR may store the updated medical document with the newly corrected information. Responsive to receiving the updated medical document, processor 50 may receive a notification that a modification has been made to the medical document and processor 50 may again analyze the medical document for any remaining copy-paste passages having a high risk level. Alternatively, responsive to receiving an indication of user input selecting update document button 314, processor 50 may again analyze the medical document for any copy-paste passages. Interface module 72 may also display user interface screen 258 in response to user selection of update document button 314. Interface module 72 may again display notification 270 if any further copy-paste passages of high risk are identified in one or more medical documents.

The techniques of this disclosure may be implemented in a wide variety of computer devices, such as one or more servers, laptop computers, desktop computers, notebook computers, tablet computers, hand-held computers, smart phones, or any combination thereof Any components, modules or units have been described to emphasize functional aspects and do not necessarily require realization by one or more different hardware units.

The disclosure contemplates computer-readable storage media comprising instructions to cause a processor to perform any of the functions and techniques described herein. The computer-readable storage media may take the example form of any volatile, non-volatile, magnetic, optical, or electrical media, such as a RAM, ROM, NVRAM, EEPROM, or flash memory that is tangible. The computer-readable storage media may be referred to as non-transitory. A server, client computing device, or any other computing device may also contain a more portable removable memory type to enable easy data transfer or offline data analysis.

The techniques described in this disclosure, including those attributed to server 22, repository 24, and/or computing device 100, and various constituent components, may be implemented, at least in part, in hardware, software, firmware or any combination thereof For example, various aspects of the techniques may be implemented within one or more processors, including one or more microprocessors, DSPs, ASICs, FPGAs, or any other equivalent integrated or discrete logic circuitry, as well as any combinations of such components, remote servers, remote client devices, or other devices. The term “processor” or “processing circuitry” may generally refer to any of the foregoing logic circuitry, alone or in combination with other logic circuitry, or any other equivalent circuitry.

Such hardware, software, firmware may be implemented within the same device or within separate devices to support the various operations and functions described in this disclosure. For example, any of the techniques or processes described herein may be performed within one device or at least partially distributed amongst two or more devices, such as between server 22 and/or client computing device 12. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Example computer-readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or any other computer readable storage devices or tangible computer readable media. The computer-readable storage medium may also be referred to as storage devices.

In some examples, a computer-readable storage medium comprises non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described herein. Any combination of the described operations or functions is contemplated. These and other examples are within the scope of the following claims.

What is claimed is:

1. A computer-implemented method for managing medical information, the method comprising:
receiving, by a computing device, a second medical document related to a patient encounter;
determining, by the computing device, that a passage of the second medical document has been copied from a first medical document;
determining, by the computing device, a risk level for the passage, the risk level indicating a likelihood that the passage includes inaccurate information regarding the patient encounter;
determining, by the computing device, that the risk level exceeds a risk threshold; and
outputting, by the computing device, an indication of the passage for which the risk level exceeds the risk threshold.

2. The method of claim 1, wherein determining that the passage of the second medical document has been copied from the first medical document comprises:
comparing content of the second medical document to content of one or more other medical documents, the one or more other medical documents comprising the first medical document;
identifying, based on the comparison, a second continuous text string from the content of second medical document as identical to a first continuous text string of the content of the first medical document; and
determining that the second continuous text string having a number of words greater than a word minimum is the passage of the second medical document that has been copied from the first medical document.

3. The method of claim 1, wherein the risk level comprises one of a low risk level or a high risk level, the high risk level exceeding the risk threshold and the low risk level not exceeding the risk threshold.

4. The method of claim 1, wherein determining the risk level for the passage comprises:
determining, by a risk analysis module of the computing device, that the passage has been at least one of copied from a restricted region of the first medical document or pasted into a restricted region of the second medical document, the restricted region comprising medical information typically different between different patient encounters; and
responsive to determining that the passage has been at least one of copied from the restricted region of the first medical document or pasted into the restricted region of the second medical document, determining, by the risk analysis module, that the passage has a high risk level exceeding the risk threshold.

5. The method of claim 4, wherein determining the risk level for the passage comprises determining a percentage of text in the restricted region of the second medical document copied from the first medical document.

6. The method of claim 1, wherein determining the risk level for the passage comprises:
determining, by a risk analysis module of the computing device, that the passage contains a text string typically different between different patient encounters; and
responsive to determining that the passage contains the text string typically different between different patient encounters, determining, by the risk analysis module of the computing device, that the passage has a high risk level exceeding the risk threshold.

7. The method of claim 1, wherein determining the risk level for the passage comprises:
determining, by a risk analysis module of the computing device, that the passage contains information incompatible with other passages of the second medical document, wherein the information is incompatible when the information at least one of includes a different grammatical tense than information of the other passages, is in direct conflict with information of the other passages, or contains subject matter inconsistent with subject matter of the other passages; and
responsive to determining that the passage contains information incompatible with other passages of the second medical document, determining, by the risk analysis module of the computing device, that the passage has a high risk level exceeding the risk threshold.

8. The method of claim 1, wherein outputting the indication of the passage comprises outputting, for display as highlighted text, at least a portion of the passage contributing to the determined risk level.

9. The method of claim 1, wherein outputting the indication of the passage comprises outputting, for display, a percentage match between the passage of the second medical document and a copied portion of the first medical document.

10. The method of claim 1, wherein the inaccurate information comprises information specific to the first medical document instead of the second medical document.

11. The method of claim 1, wherein the patient encounter is a second patient encounter, and wherein the first medical document is related to a first patient encounter that occurred prior to the second patient encounter.

12. The method of claim 1, wherein the second medical document is related to the patient encounter for a second patient, and wherein the first medical document is related to a patient encounter for a first patient different than the second patient.

13. The method of claim 1, wherein the second medical document has been generated after the first medical document.

14. The method of claim 1, further comprising:
receiving, from a medical professional associated with the patient encounter, an indication of user input that one of confirms the passage is correct or modifies at least a portion of the passage; and
responsive to receiving the indication of the user input, removing the indication of the passage for which the risk level exceeds the risk threshold.

15. A computerized system for managing medical information, the system comprising:
one or more computing devices configured to:
receive a second medical document related to a patient encounter;
determine that a passage of the second medical document has been copied from a first medical document;
determine a risk level for the passage, the risk level indicating a likelihood that the passage includes inaccurate information regarding the patient encounter;
determine that the risk level exceeds a risk threshold; and
output an indication of the passage for which the risk level exceeds the risk threshold.

16. The system of claim 15, wherein the one or more processors are configured to determine that the passage of the second medical document has been copied from the first medical document by:
comparing content of the second medical document to content of one or more other medical documents, the one or more other medical documents comprising the first medical document;
identifying, based on the comparison, a second continuous text string from the content of second medical document as identical to a first continuous text string of the content of the first medical document; and
determining that the second continuous text string having a number of words greater than a word minimum is the passage of the second medical document that has been copied from the first medical document.

17. The system of claim 15, wherein the one or more processors are configured to determine the risk level for the passage by:
determining that the passage has been at least one of copied from a restricted region of the first medical document or pasted into a restricted region of the second medical document, the restricted region comprising medical information typically different between different patient encounters; and
responsive to determining that the passage has been at least one of copied from the restricted region of the first medical document or pasted into the restricted region of the second medical document, determining that the passage has a high risk level exceeding the risk threshold.

18. The system of claim 15, wherein the one or more processors are configured to determine the risk level for the passage by:
determining that the passage contains a text string typically different between different patient encounters; and
responsive to determining that the passage contains the text string typically different between different patient encounters, determining that the passage has a high risk level exceeding the risk threshold

19. The system of claim 15, wherein the one or more processors are configured to determine the risk level for the passage by:
determining that the passage contains information incompatible with other passages of the second medical document, wherein the information is incompatible when the information at least one of includes a different grammatical tense than information of the other passages, is in direct conflict with information of the other passages, or contains subject matter inconsistent with subject matter of the other passages; and
responsive to determining that the passage contains information incompatible with other passages of the second medical document, determining that the passage has a high risk level exceeding the risk threshold.

20. The system of claim 15, wherein the one or more processors are configured to output the indication of the passage by outputting, for display as highlighted text, at least a portion of the passage contributing to the determined risk level.

21. The system of claim 15, wherein the inaccurate information comprises information specific to the first medical document instead of the second medical document.

22. The system of claim 15, wherein the second medical document has been generated after the first medical document.

23. The system of claim 15, wherein the one or more processors are configured to:
receive, via a user interface and from a medical professional associated with the patient encounter, an indication of user input that one of confirms the passage is correct or modifies at least a portion of the passage; and
responsive to receiving the indication of the user input, remove the indication of the passage for which the risk level exceeds the risk threshold.

24. A computer-readable storage medium comprising instructions that, when executed, cause one or more processors to:
receive a second medical document related to a patient encounter;
determine that a passage of the second medical document has been copied from a first medical document;
determine a risk level for the passage, the risk level indicating a likelihood that the passage includes inaccurate information regarding the patient encounter;
determine that the risk level exceeds a risk threshold; and
output an indication of the passage for which the risk level exceeds the risk threshold.
